(19) United States
(12) Patent Application Publication
(10) Pub. No.: US 2012/0004982 A1
(43) Pub. Date: Jan. 5, 2012

(54) Method And System For Automated Selection And Generation Of Video Advertisements

(75) Inventors: Brian Cohee, Shoreline, WA (US); David Meeuwis, Victoria (CA); Karl Godard, Vancouver (CA); Zhu Xiong, Bothell, WA (US); Brian Oraas, Victoria (CA); Matthew Bartholomew, Everett, WA (US)

(73) Assignee: MIXPO PORTFOLIO BROADCASTING, INC., Seattle, WA (US)

(21) Appl. No.: 13/217,196

(22) Filed: Aug. 24, 2011

Related U.S. Application Data
(63) Continuation-in-part of application No. 12/173,010, filed on Jul. 14, 2008.

(51) Int. Cl. G06Q 30/00

(52) U.S. Cl. 705/14.42; 705/14.49; 705/14.73; 705/14.58

(57) ABSTRACT

A method for publishing video ads inside Web pages, including enabling a publisher using a publisher computer to specify a first video ad, and instructions for generating a second video ad from the first video ad, generating a playlist for the first video ad, uploading the playlist to a video ad server along with the instructions for generating a second video ad, in response to a request to play the first video ad from a smart media player that executes in a viewer computer, processing the instructions to generate a second video ad thereby generating by the video ad server a playlist that corresponds to the second video ad, and providing the playlist corresponding to the second video ad to the smart media player.

### PRIORITY REFERENCE TO RELATED APPLICATIONS

This application is a continuation-in-part of pending application U.S. Ser. No. 12/173,010, filed on Jul. 14, 2008, entitled “Method And System For Customizable Video Advertising.”

### FIELD OF THE INVENTION

The subject invention relates to video advertising over the Internet and specifically to the ability of a video ad server to automatically select and generate video advertisements based on criteria defined by a publisher and based on information about the viewer of the video advertisements.

### BACKGROUND OF THE INVENTION

Increasingly, companies are turning to online video to advertise their products and services. For example, companies frequently describe aspects of their businesses by publishing video advertisements on their websites. In some cases components of these video advertisements, also referred to simply as video ads, were originally developed as television commercials. These video ads may appear as display ads within web pages. In addition, it is common on commercial websites to show a short video advertisement or “video ad” prior to the video clip that an individual has requested.

Advertisers often wish to test several alternative advertisements with viewers prior to committing to an advertising campaign. For example, it is often desirable to test the response of viewers with different demographic profiles, e.g. age, and gender. Thus, facilities that enable a viewer to easily create and test alternative advertisements are desirable.

In some cases, a publisher or creator of video advertisements has, or can obtain, information about the viewer requesting the video clip that may be used to provide targeted or customized advertising specific to the viewer. For example, if the viewer has signed on to the website and the website has previously collected personal information from the user then the website can in turn provide to the advertiser information such as the user's age, gender, or geographic location. In addition, it is possible to obtain approximate geographic coordinates for the location of the viewer. An advertiser may then use such information about the viewer to customize an ad, taking into account location or other information about the viewer.

Video advertisements, repurposed television commercials, and business-related videos are typically created on a client computer, uploaded to an online video advertising system on a central server, and then distributed upon request by a viewer from the central server to the viewer's Web browser. Other client computers typically display the video clip using a media player that operates as a plug-in or otherwise in conjunction with a Web browser. Popular media players include APPLE® QUICKTIME®, MICROSOFT® MEDIA PLAYER, ADOBE® FLASH®, and REALPLAYER® by REALNETWORKS®. Popular Web browsers include MICROSOFT INTERNET EXPLORER® and MOZILLA FIREFOX. A client computer may also be a mobile device such as an APPLE IPHONE® or APPLE IPAD® that runs a mobile Web browser.

Typically, if a change or update needs to be made to the video file (for example, customizing an address based on the geographic location of the viewer), the file must be edited on a client computer using video editing software such as MICROSOFT WINDOWS® MOVIE MAKER, or APPLE IMOVIE® and resubmitted to the hosting server with a different video filename. The reason for this time consuming process is that prior art video publishing and video advertising systems require that a video be submitted as a single video file in a standard format (e.g., .FLV or .MP4). Thus, prior to submitting a video the video editing software must merge or flatten all of the individual media elements (digital video, sound or music, and text files) of which a video is composed to create a video output file capable of being uploaded to an online advertising system.

Therefore, to facilitate the creation of customized Internet video ads it is advantageous to store on the server a representation of an advertisement in which the media elements have not been merged. In such a system it is possible to customize an advertisement on the server simply by changing the elements that are to be customized. For example, a text overlay that provides the address of the nearest automobile dealership can be readily chosen from thousands of possible overlays.

However, due to the large number of possible combinations involved in customized advertising it is computationally prohibitive to have server computers generate new self-contained video clips in real-time in response to viewer requests. Moreover, such a server-based approach would result in delays while the server is generating the new video clip, which might be undesirable to the viewer. Therefore, it is advantageous to have a client-based approach that enables creation of a customized video ad at the time a viewer requests playback of a video ad. Further, it is advantageous if the client can render the customized ad in real-time thus avoiding network transmission delays or server-based processing delays.

Media players are becoming increasingly programmable, thus enabling the creation of customized video ads on-the-fly. SMIL (Synchronized Multimedia Integration Language) was initially created by REALNETWORKS to choreograph multimedia presentations of audio, video, text, and graphics in real-time. SMIL is a markup language for specifying how and when media clips play in a SMIL-enabled media player. SMIL was subsequently adopted as a standard by the World Wide Web Consortium (W3C). Several media players support the SMIL standard including REALPLAYER, provided by REALNETWORKS (RealNetworks, Inc., Seattle, Wash.). The advantage of generating a multimedia presentation on the client is that if a portion of the multimedia presentation needs to be edited, such as a line of text, it is possible to edit only the text and not re-render or re-generate the entire video. This speeds up the editing process and decreases the cost of creating and maintaining multimedia content.

SAMI (Synchronized Accessible Media Interchange) was created by Microsoft (Microsoft Corporation, Bellevue, Wash.) to enable client-side captioning of digital media shown through a media player. SAMI captions are stored as text files, separate from the multimedia content. This enables captions to be easily modified, maintained, customized, and localized for different languages.

More recently, online video broadcasting services such as YouTube, and Yahoo!® Video have successfully attracted millions of users. These systems use the ADOBE FLASH media player from ADOBE Systems of San Jose, Calif., to play videos that are stored in the FLV (FLASH Video) encoding format on a central server. Recently ADOBE introduced the Flex™ system that includes the ActionScript 3 language for scripting the FLASH Version 9 and later player. ActionScript 3 is used primarily for the development of website features and software that use the FLASH Version 9 and later player.

### SUMMARY OF THE DESCRIPTION

The subject invention concerns a system and method for creating, storing, and serving a video ad in a smart media player that displays the ad in a standard Web browser. Using the subject invention, an advertiser can publish his or her video ad over the Web. Video ads can be viewed within conventional Web browsers that use smart media players, such as the ADOBE FLASH player, or using built-in video-rendering capabilities supported by the browser, e.g., the HTML5 standard. The ADOBE FLASH player is generally available on most platforms and Web browsers. As such, the subject invention does not require additional viewing software. The broadcaster, also referred to as an advertiser, creates a video ad using the subject invention and publishes the video ad on websites. Viewers can then select the multimedia video ads for viewing.

The subject invention is also particularly advantageous for advertisers who wish to customize aspects of a video ad for each viewer, based on information about that viewer, e.g., age, gender, and location.

There is thus provided in accordance with an embodiment of the present invention a method for (to be completed).

There is additionally provided in accordance with an embodiment of the present invention a system for (to be completed)

### BRIEF DESCRIPTION OF THE DRAWINGS

The best way to understand and appreciate the subject invention is in conjunction with the attached drawings. The drawings are summarized briefly below and then referred to in the Detailed Description that follows.

FIG. 1 is a simplified block diagram of a video ad system used by publishers to create, store, serve, and play video ads, in accordance with an embodiment of the subject invention;

FIG. 2A is an exemplary user interface of a video ad editor program used to create video ads, in accordance with an embodiment of the subject invention;

FIG. 2B is an exemplary user interface that illustrates publishing options available to a publisher when publishing a video ad, in accordance with an embodiment of the subject invention;

FIG. 2C is an exemplary user interface that illustrates syndication options available to a publisher when publishing a video ad, in accordance with an embodiment of the subject invention;

FIG. 2D is an exemplary user interface that illustrates an analytics dashboard that provides viewer playback statistics for a video ad, in accordance with an embodiment of the subject invention;

FIG. 3 is an exemplary user interface that illustrates a video ad displayed in a standard Web page, in accordance with an embodiment of the subject invention.

FIG. 4 is a simplified flow diagram depicting an overall method that enables a publisher to create a video ad, store a playlist and its component media clips on a video ad server, and serve the ad to a smart media player in response to a user request, in accordance with an embodiment of the present invention;

FIG. 5 is a simplified block diagram depicting the viewer client software architecture, in accordance with an embodiment of the subject invention;

FIG. 6 is a simplified transaction diagram depicting the exchange of data between a Web browser, FLASH player, video ad player, and video ad server in response to a request for a video ad playback by a viewer, in accordance with an embodiment of the present invention;

FIG. 7 is a simplified block diagram depicting the software modules provided by a video ad server, in accordance with an embodiment of the subject invention; and

FIG. 8 is a simplified block diagram depicting an exemplary hardware architecture for implementing a video ad server, in accordance with an embodiment of the present invention.

FIG. 9 is a block diagram of a video ad publishing system and a video ad server that enable the selection of video ads based on criteria established by a publisher and the automatic generation of video ads, in accordance with an embodiment of the subject invention.

FIG. 10 is an exemplary dashboard user interface that enables a publisher to manage video ads, create new video ads based on an existing video ad, and to view performance results for video ads, in accordance with an embodiment of the subject invention.

FIG. 11 is an exemplary user interface that enables a publisher to create one or more copies of a video ad, in accordance with an embodiment of the subject invention.

FIG. 12A is an exemplary user interface that enables publisher to specify an age interval to be used among the criteria for selecting from among a plurality of video ads to provide in response to a request to view a video ad, in accordance with an embodiment of the subject invention.

FIG. 12B is an exemplary user interface that enables publisher to specify time of day criteria to be used to select from among a plurality of video ads, in accordance with an embodiment of the subject invention.

FIG. 12C is an exemplary user interface that enables publisher to specify the relative percentage of times that a video ad will be selected from among a plurality of video ads, in accordance with an embodiment of the subject invention.

FIG. 12D is an exemplary user interface that enables publisher to specify a sequence of video ads to be provided in response to successive requests for video ads, in accordance with an embodiment of the subject invention.

FIG. 13 is a simplified flow diagram depicting an overall method that enables a publisher to create a plurality of video ads and to specify criteria for selecting among the plurality of video ads and which enables a video ad server to select from among a group of alternative video ads, in accordance with an embodiment of the subject method.

FIG. 14 provides an example of how a publisher specifies a video ad that will be generated on the fly, in accordance with an embodiment of the subject invention.

FIG. 15 is a simplified flow diagram depicting an overall method that enables a publisher to specify instructions for generating a custom video ad and which enables a video ad server to generate the custom video ad and to download it to a viewer client computer, in accordance with an embodiment of the subject method.

### DETAILED DESCRIPTION

The subject invention concerns video broadcasting and video advertising. Using the subject invention, a publisher can create, broadcast, and easily customize video content to the Web from his client computer. The rendering of sophisticated multimedia or video broadcasts is performed on another client computer by a smart media player (e.g., using FLASH or Web browser with HTML5 support), enabling videos to be customized in real-time following a playback request by a viewer.

As used herein the following terms have the meanings given below:

Viewer—means an individual that uses a client computer to view a video ad that appears in a Web browser.

Publisher—means an individual that prepares the video ad using a video ad editing program or “editor” and publishes the video ad to the Web.

Media file or media clip—means a computer file containing inter alia video, image sound, music, or graphics. A media clip may also contain digital images that are displayed for a specified period of time.

Interactive element—means a user interface field in which the viewer may enter text or select from a list. Examples include multiple choice selections (e.g., surveys), data entry fields, radio buttons, and menus.

Playlist—means a computer file that describes how to combine or “render” inter alia media clips, text, background images or colors, and interactive elements to produce a video ad capable of being displayed inside a Web browser window. As used herein, a playlist references but does not include the media clips included in a video ad.

Media player—means a software module that displays media within a Web page and operates in conjunction with a Web browser such as Microsoft Internet Explorer or Mozilla Firefox. Typically the Web media player displays the media inside a rectangular box in a Web page. Web media players include the MICROSOFT MEDIA PLAYER, APPLE QUICKTIME, and REALNETWORKS REALPLAYER. In some embodiments (e.g., HTML5), the Web browser itself may act as a media player.

Smart media player—means a type of media player that is programmable, enabling the creator of a multimedia broadcast to specify a sequence of media clips, interactive elements, and text or sound overlays that will be rendered by the smart player and played. The ADOBE FLASH Version 9 and later player is an example of a smart media player. In some embodiments, the Web browser itself or a separate client application may act as a smart media player.

Video advertisement (henceforth referred to as a video ad)—means a video or multimedia presentation that results when a smart media player renders a playlist to a Web browser window. A video ad includes one or more media clips and digital images, digital sound files including digital music, and text, and interactive elements which are combined to produce a video presentation capable of being displayed on a web browser. As used herein, the playlist and component media clips are delivered across a network such as the Internet to a smart media player which renders the video ad into a window in a Web browser. In one embodiment, a playlist is in XML format. Alternatively, a playlist may be in a proprietary binary or textual format.

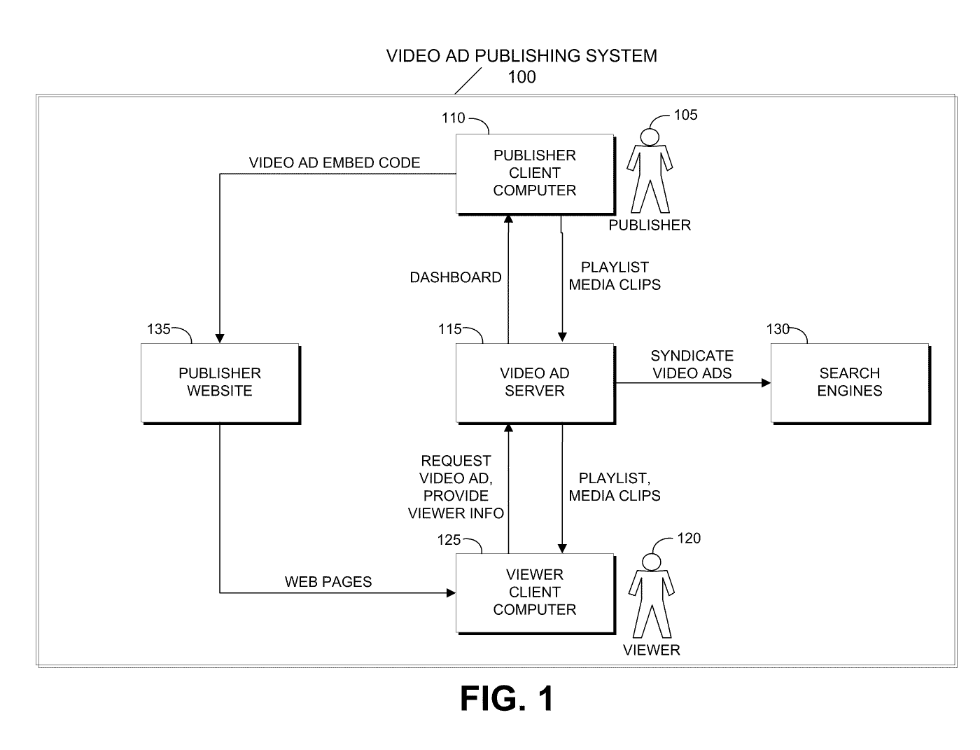

It may be appreciated that a video ad is not restricted to being a commercial advertisement. A video ad may be inter alia a documentary, a music video, a news broadcast, a business presentation, or a sequence of personal video clips. The term video ad is therefore employed because the overall video ad system, described in further detail with respect to FIG. 1 has unique advantages for the creation and publishing of video advertisements but nothing about the present invention limits the subject matter or intended usage of a video ad to commercial advertising.

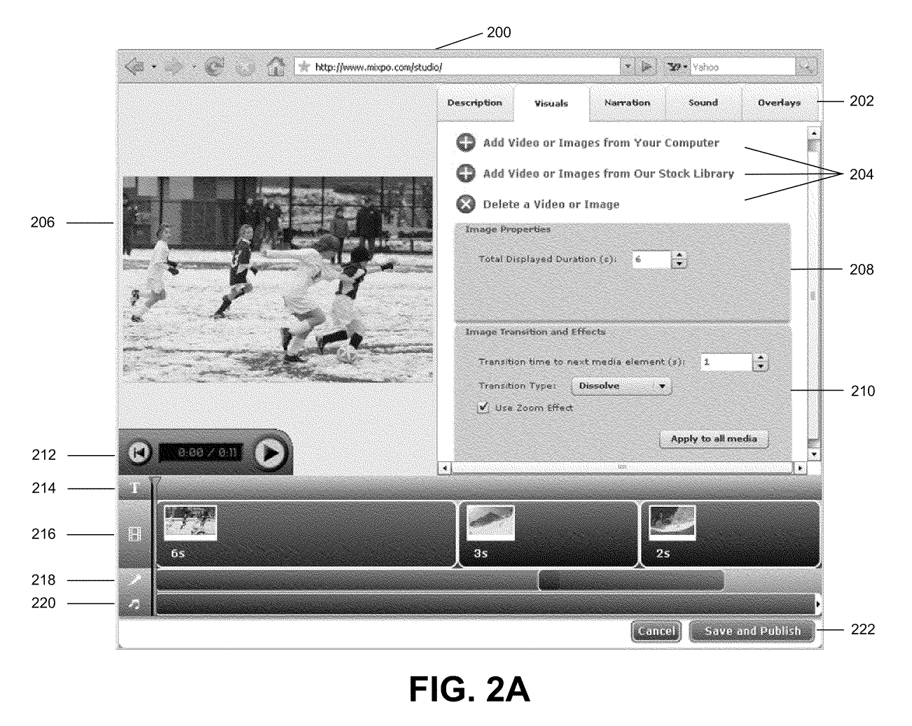

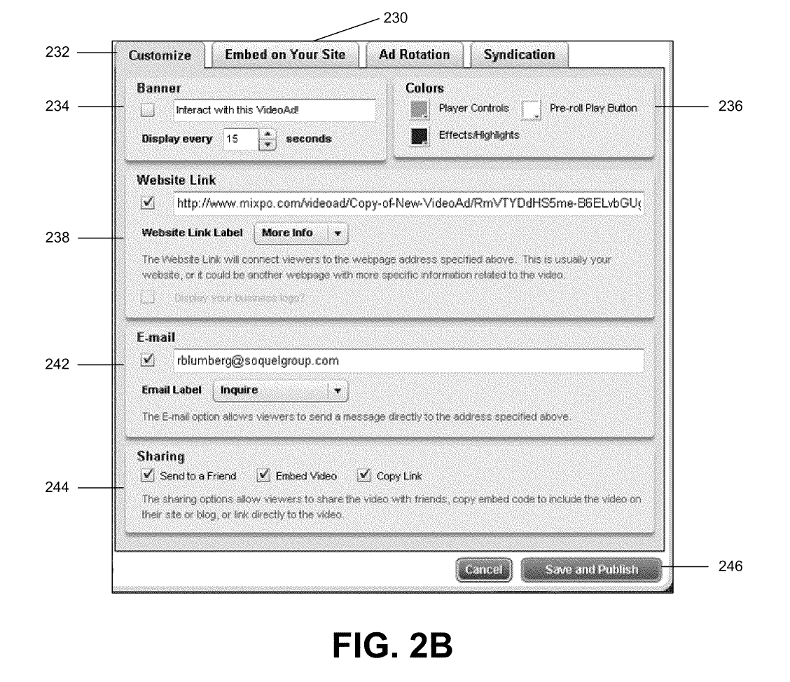

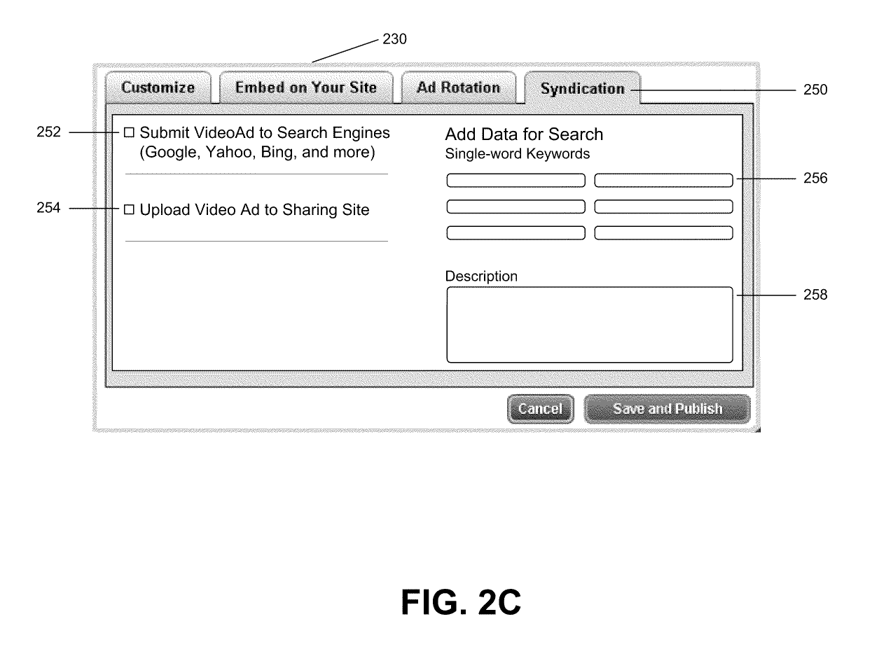

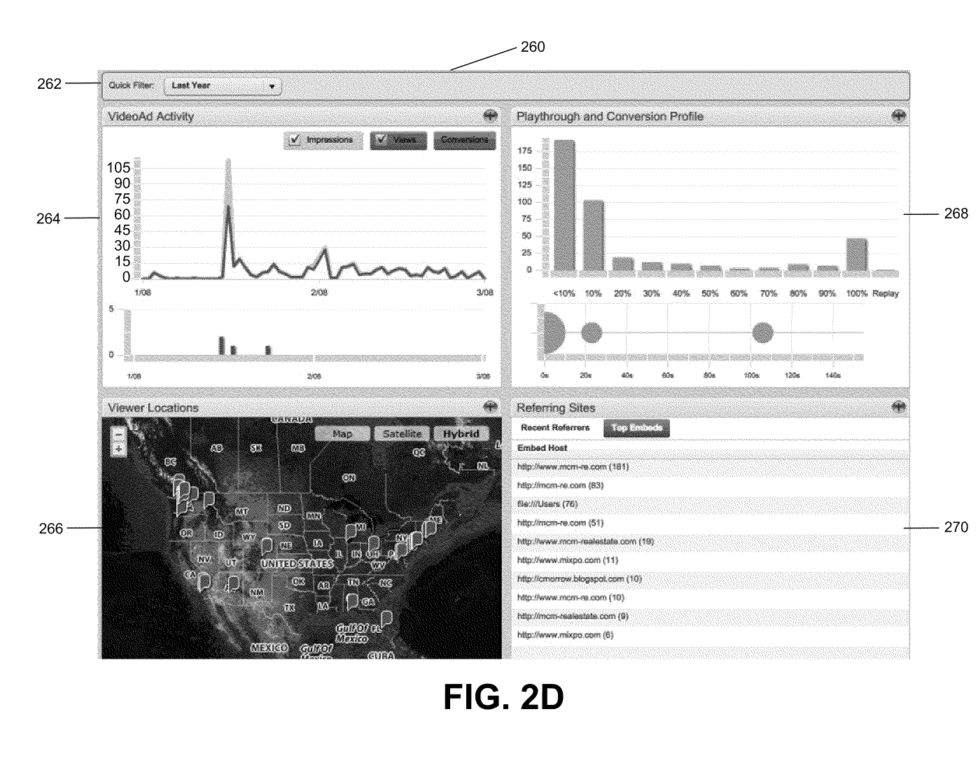

Reference is now made to FIG. 1, which is a simplified block diagram of a video ad system used by publishers to create, store, serve and play video ads, in accordance with an embodiment of the subject invention. Shown in FIG. 1 is a video ad publishing system 100 that enables content providers, referred to as publishers, to broadcast media over the Web. A publisher 105 creates a video ad using a video ad editing program, also referred simply as an editor, or publisher interface, that runs on a publisher client computer 110. The editor creates a playlist that includes the instructions for rendering separately stored media clips together with information such as text and image overlays and timing to create and play a video ad. The editor is described in greater detail with respect to FIGS. 2A-2C.

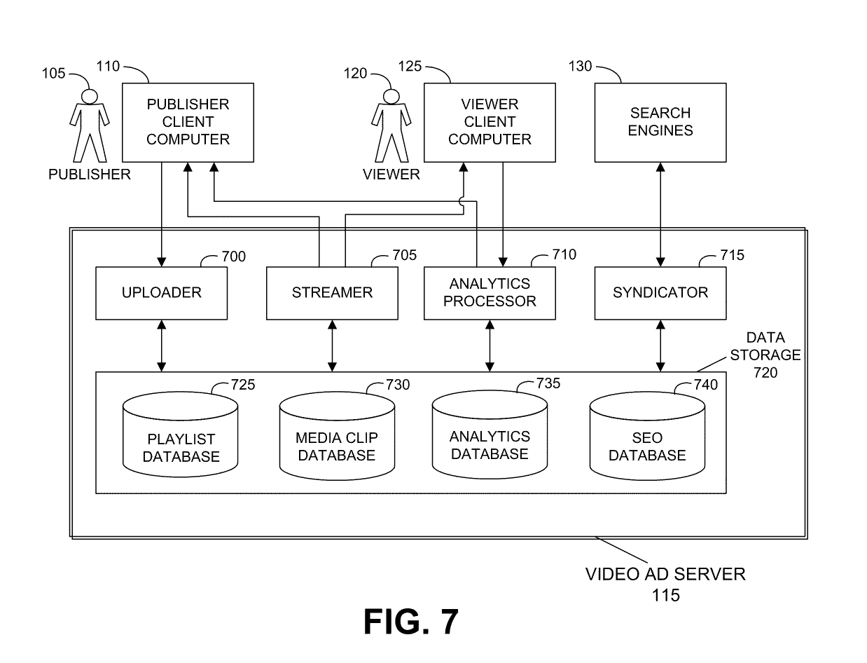

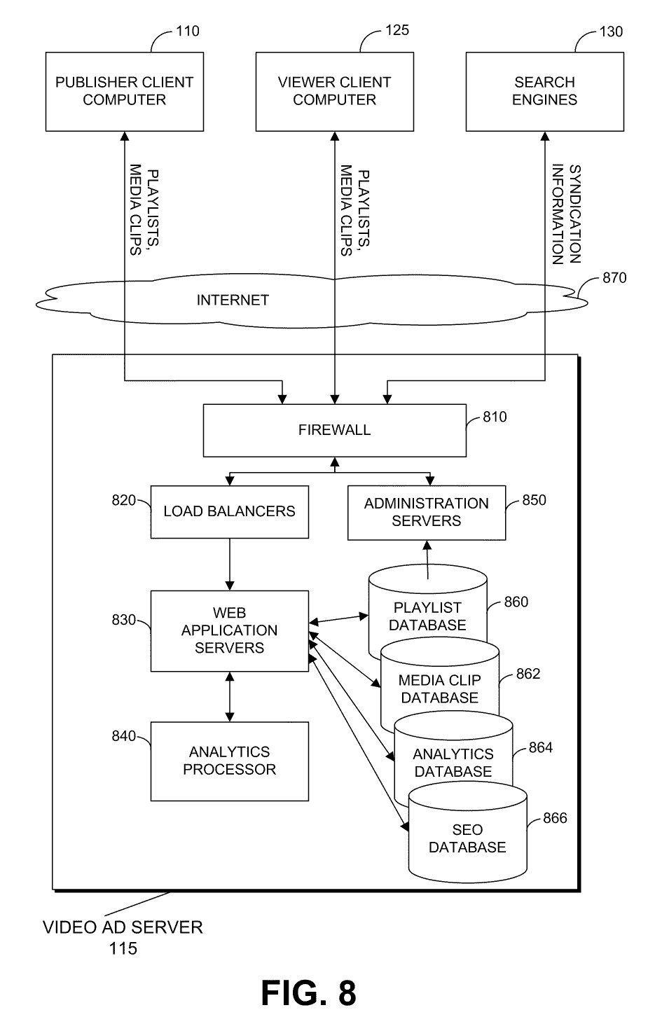

Video ad server 115 is a computer server, network computing device, or service that interacts across a wide area network, such as the Internet, local area network, mobile network or combination thereof with publisher client computer 110, a viewer client computer 125 and, optionally, with search engines 130. Video ad server 115 is described in further detail with reference to FIGS. 7 and 8.

Video ad server 115 provides a dashboard to publisher client computer 110, which is a user interface than enables publisher 105 to control various aspects of the video ad publishing process. The dashboard user interface is described in further detail hereinbelow with reference to FIGS. 2B-D and 12A-D. The dashboard provides publisher client computer 110 an embed code for the video ad, which is a type of uniform resource locator (URL), which can be embedded in a web page. The video ad embed code causes a web browser that is processing a web page in which it is embedded to issue a request to video ad server 115 to download the playlist corresponding to the requested video ad. Publisher 105, using publisher client computer 110, inserts the video ad embed code into one or more web pages on publisher website 135.

When publisher 105 completes creating the video ad he/she uses a publish control provided by the dashboard to indicate that the video may be “published.” Publisher client computer 110 then uploads the playlist together with any media clips referenced in the playlist, text, or other elements created using the editor to video ad server 115. Video ad server 115 then performs additional processing steps which result in the video ad being published, i.e., being made available for viewing by a viewer 120 using viewer client computer 125. At the option of publisher 105, video ad server 115 syndicates the video ad to video search engines 130. Syndication of video ads is described in further detail with respect to FIG. 2C. In another embodiment, the video ad is made available by one or more ad networks, such as the GOOGLE OR YAHOO! ad networks, for incorporation into a plurality of websites.

Viewer 120 uses a browser running in viewer client computer 125 to view web pages on publisher website 135. When a web page provided by publisher website 135 includes a video ad embed code, the browser running in viewer client computer 125 executes the embed code which causes it to issue a request for the referenced playlist to video ad server 115. The request message sent to video ad server 115 typically includes information about viewer 120 such as demographic information, and/or information about viewer client computer 125 such as its IP address or geographic coordinates. Video ad server 115 responds by downloading the playlist to viewer client computer 125 which in turn processes the playlist and thus plays the video ad for viewer 120.

Viewer client computer 120 may be any computer equipped with a network capability and a display capable of processing a playlist, displaying the corresponding video ad to viewer 120. For example, viewer client computer 120 may be a personal computer, a smart phone or other mobile device, or tablet computer. Viewer client computer 120 is typically equipped with a keyboard and/or other input device such as a mouse, trackball, or touchpad that enables viewer 120 to interact with a web browser application.

Reference is now made to FIG. 2A, which is an exemplary user interface of a video ad editor program used to create and publish video ads, in accordance with an embodiment of the subject invention. In the embodiment depicted in FIGS. 2A-2C, the editor is a Web program that can be implemented inter alia as an ADOBE Flex (FLASH) program that runs in the Web browser's FLASH player. Similarly, an analytics dashboard described with reference to FIG. 2D is a Web program that can be implemented inter alia as a Flex (FLASH) program that runs in a Web browser's FLASH player. The editor initially displays user interface 200 which enables publisher 105 to create, store on video ad server 105, and publish a video ad. A series of media tabs 202 enable publisher 105 to provide a description of the video ad, specify visuals which include one or more digital images and/or digital videos, record or select one or more audio narration files, select one or more sound files, and specify one or more text overlays.

The visuals tab from media tabs 202 provides file controls 204 that enable publisher 105 to add a video or images inter alia from the publisher's client computer, from another video ad in the publisher's account, or from images in a stock library. File controls 204 further enable publisher 105 to delete a video or image. Publisher 105 uses an image properties control 208 to specify the duration of the video clip or image. Publisher 105 uses a set of image transition and effects controls 210 to specify the transition time in seconds between adjacent media elements (also referred to as media clips), to select a transition type from a menu of effects, and to specify whether to use a zoom effect. Publisher 105 may optionally apply the settings from image transition and effects controls to all media clips.

Publisher 105 can preview the video ad using a set of preview controls 212. A series of preview controls 212 enable publisher 105 to preview how the video ad will appear when played in a browser window. At the bottom of user interface 200, a series of timeline controls enable publisher 105 to select and edit: text elements (control 214), image and video clip properties (control 216), narration clips, and music clip properties (control 220). Finally, a publish control 222 enables publisher 105 to save and publish the video ad or to cancel and not save any edits made.

Reference is now made to FIG. 2B, which is an exemplary user interface that illustrates publishing options available to a publisher when publishing a video ad, in accordance with an embodiment of the subject invention. A publishing options dialog box 230 offers a series of publishing options tabs 232 that enable publisher 105 to customize aspects of the video ad, embed the video ad on a website, define ad rotation options, and specify syndication options. In the example user interface, a customize tab is active. A set of banner controls 234 enable publisher 105 to display or hide and customize the label for a banner that draws viewers' attention to the built-in calls to action. A set of color controls 236 enable publisher 105 to specify the color and effects/highlights of the media player controls and calls to action and the color of the pre-roll play button.

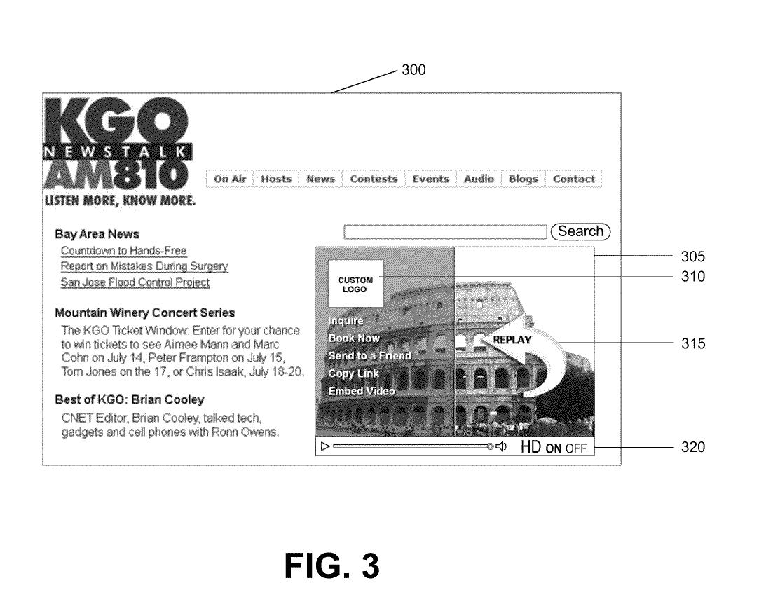

A set of website link controls 238 allows publisher 105 to specify the Uniform Resource Locator (URL) for a Web page, to be displayed for viewers who click a More Info call to action that is consequently embedded in the video ad. Typically, the Web page shown when a view clicks a More Info call to action enables viewers to learn more about the company and products of publisher 105. Website link controls 238 further enable publisher 105 to customize the label of the More Info call to action. An example of a More Info call to action is illustrated in FIG. 3.

A set of email controls 242 allows publisher 105 to specify the email address associated with an Inquire call to action. When viewer 120 clicks Inquire, a form opens that allows viewer 120 to send an inquire email message to publisher 105. If publisher 105 does not want to include an Inquire call to action, he/she can uncheck the box. Email controls 242 further enable publisher 105 to customize the label for the Inquire call to action.

A set of sharing controls 244 allow publisher 105 to include any of the Send to a Friend, Embed Video, and Copy Link calls to action with the video ad. When viewers 120 click Send to a Friend, a form opens that allows viewers to send a link to the video ad to a number of friends. When viewers 120 click Embed Video, a form opens that provides them with code they can copy and paste to include the video ad in their own Web sites. When viewers 120 click Copy Link, a form opens that allows them to easily copy a link to the video ad that they can paste into pages on their own site or send through email.

Finally, a publish control 246 enables publisher 105 to save the publishing options along with the video ad and to publish the video ad, or to cancel and not save the publishing option selections.

Reference is now made to FIG. 2C, which is an exemplary user interface that illustrates syndication options available to a publisher when publishing a video ad, in accordance with an embodiment of the subject invention. FIG. 2C illustrates the syndication options available from a syndication tab 250 available from publishing options dialog box 230 described with reference to FIG. 2B. A submit video ad to search engines control 254 enables publisher 105 to specify whether he/she wants video ad server 115 to automatically submit the video ad to search engines. If publisher 105 selects the submit control, then video ad server 254 provides information about the video ad to a plurality of search engines that offer specific methods for indexing videos including inter alia AOL VIDEO, YAHOO! VIDEO and GOOGLE VIDEO, and MICROSOFT BING. An upload video ad to sharing site control 254 enables publisher 105 to specify whether he/she wants the video ad to be uploaded to video sharing sites such as GOOGLE YOUTUBE. A set of keyword entry fields 256 enable publisher 105 to specify keywords for the video ad that will be submitted along with the video ad to search engines and sharing sites. A description field 258 enables publisher 105 to enter a description of the video ad that will be submitted along with the video ad to search engines and sharing sites.

Reference is now made to FIG. 2D, which is an exemplary user interface that illustrates an analytics dashboard that provides viewer playback statistics for a video ad, in accordance with an embodiment of the subject invention. An analytics dashboard 260 enables publisher 105 to view usage statistics for each video ad that he/she has published either individually, or in any combination. Publisher 105 may use a quick filter 262 to select a time period for the statistics presented by dashboard 260. Dashboard 260 presents four example panels, a video ad activity panel 264, a viewer locations panel 266, a playthrough and conversion profile panel 268, and a referring sites panel 270.

Video ad activity panel 264 presents the number of impressions, views, and conversions for a video ad for the selected time period. A view is when a viewer explicitly requests to view a video ad, or when the video ad is embedded in a Web page in auto-play mode and is served to a viewer. In auto-play mode, the video ad commences playing when the video ad appears; viewer 120 doesn't have to explicitly request playback. In this example user interface, the impressions and views are presented in the top graph and conversions are presented in the lower graph.

Viewer locations panel 266 presents the geographic location of each viewer of the video ad. In one embodiment, the IP address of the requesting viewer client computer 125 is converted to a latitude and longitude using lookup tables. In another embodiment, the requesting viewer client computer 125 provides its geographic coordinates. In this example user interface, the locations are superimposed on top of a map. Typically, the map is generated in real-time by a call to a web-based mapping service such as GOOGLE™ MAPS or YAHOO! MAPS. In one embodiment, the map is provided and the location of each viewer 120 is plotted using an Actionscript 3 API provided by YAHOO! MAPS. The YAHOO! MAPS web service is provided by Yahoo!, Inc. of Mountain View, Calif. Other APIs and external map web services provided by third parties can be used as well.

Playthrough and conversion profile panel 268 displays how long viewers watched a video ad, as a percentage of the total length of the video ad during the selected period. For example, over one hundred seventy five (175) viewers played less than 10% of the video ad, while roughly forty (40) viewers played the entire video ad. Playthrough and conversion profile panel 268 also shows the number of viewers that engaged in a conversion. A conversion is defined as a viewer clicking on the “more info” control displayed by the media player, sending an email to the publisher via an “inquire” button, clicking on a text overlay during playback, or filing out a lead capture form during playback. Conversion statistics provide insight into the effectiveness of video ads.

Referring sites panel 270 lists the websites that viewers 120 were viewing prior to viewing the video ad. For each website listed, the domain URL together with the number of viewers that came from the domain is given. Selecting a “Top Embeds” control that appears in referring sites panel 270 lists the various websites that host the video ad, i.e., the websites where the video ad appears on the Web, and the number of times the video ad was viewed on each website.

Reference is now made to FIG. 3, which is an exemplary user interface that illustrates a video ad displayed in a standard Web page, in accordance with an embodiment of the subject invention. As depicted in FIG. 3, a standard Web page 300 includes a video ad 305. Video ad 305 displays a More Info call to action 310, as previously described with reference to FIG. 2B. In this example, More Info call to action 310 displays a message that reads “Custom Logo” indicating that an advertiser may place their company logo in the indicated position. A replay control 315 enables viewer 120 to replay the video ad after is completes. A group of play controls 320 enable viewer 120 to pause/play the video ad, view progress and turn on or turn off the audio associated with the video ad.

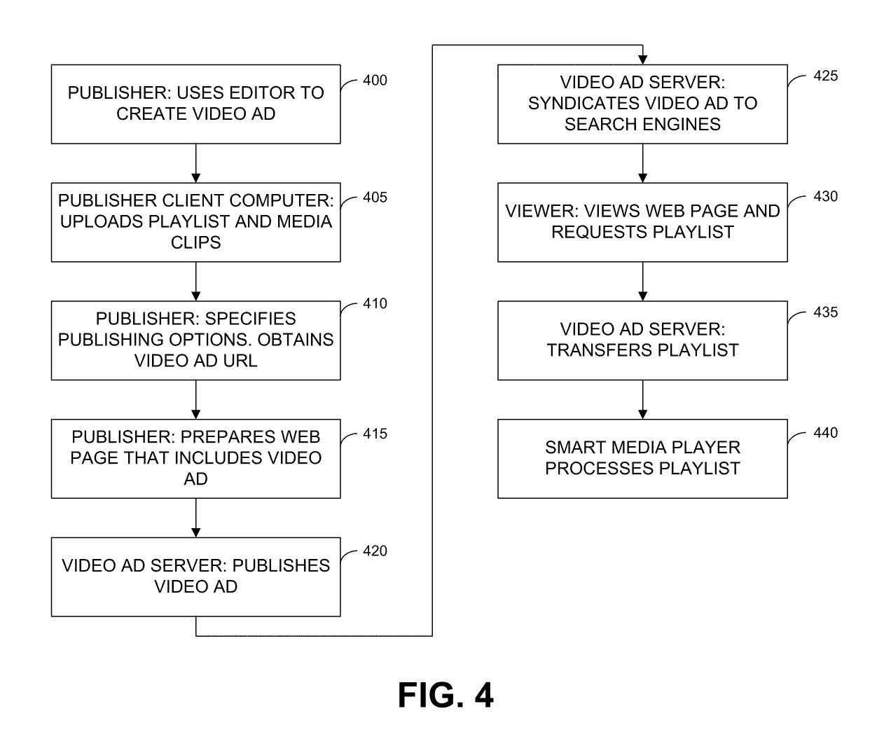

Reference is now made to FIG. 4, which is a simplified flow diagram depicting an overall method that enables a publisher to create a video ad, store a playlist and its component media clips on a video ad server, and serve the ad to a smart media player in response to a user request, in accordance with an embodiment of the present invention. At step 400 publisher 105 uses the editor, previously described with reference to FIG. 2A, to create a video ad. After creating the video ad, at step 405, the editor, running on publisher client computer 110, generates a playlist and uploads the playlist to video ad server 115 to be published. In this embodiment, any media clips that aren't already stored on video ad server 115 are uploaded along with the playlist. Because the playlist contains a reference to each media clip and does not include the media data itself, it is possible for a media clip to reside at any location on the Internet accessible using a URL, similar to how a web page will often include media items located on various web servers in various locations on the Internet.

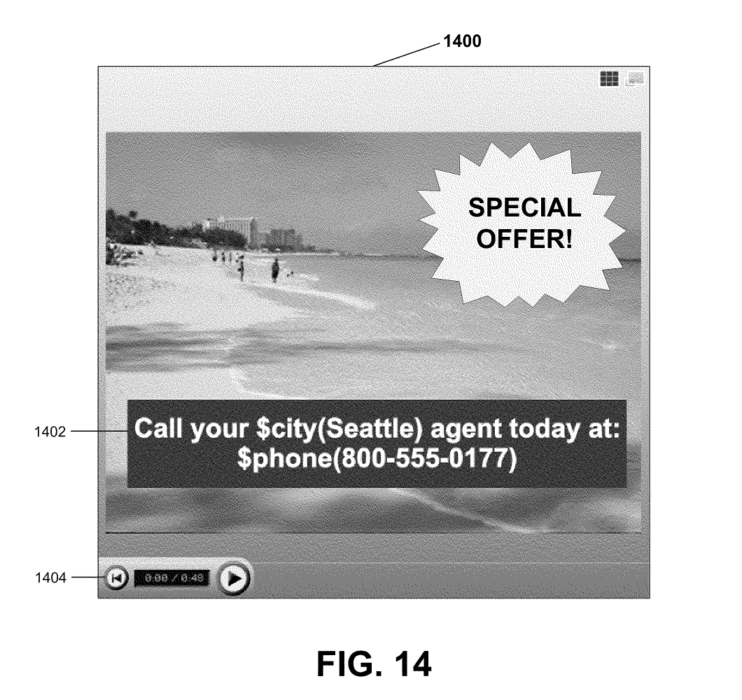

An example playlist is provided in Listing 1. The example playlist describes a video ad that contains ten images, two video clips, two audio files, and one text overlay. For each image, four different size representations are listed. For each video clip, two different bit rate representations are listed together with multiple thumbnail images extracted from the video clip. The text overlay media type includes the description and appearance of the text overlay as well as the action tied to the overlay, in this example a click-through URL. In this example playlist each media element has the same one-second “dissolve” transition. Two additional snippets, or excerpts, of a playlist are shown with reference to FIG. 14 hereinbelow.

At step 410 the editor displays publishing options dialog box 230 that enables publisher 105 to specify publishing options including options to customize the video ad, embed the video ad in a Web page, perform ad rotation, and syndicate the video ad to search engines. The customize tab of publishing options dialog box 230 presents a URL to the video ad on video ad server 115 that publisher 105.

At step 415, publisher 105 prepares a Web page, or, more typically, edits an existing Web page, on publisher website 135, to include the video ad. The Web page may be a static HTML Web page or a dynamic Web page that is generated automatically. To include the video ad, publisher 105 copies the video ad embed code provided in the customize tab of publishing options dialog box 230 into the HTML Web page in which the video ad is to appear. In one embodiment, publisher client computer 125 stores the Web page on publisher website 135 or otherwise adds the web page to publisher website 135. At step 420 video ad server 115 performs the processing required to make the video ad available for viewing by viewer 120. At step 425, if publisher 105 has requested that video ad server 115 submit the video ad to search engines using automatic SEO control 254 then video ad server 115 submits the video ad to a plurality of search engines. The processing performed by video ad server 115 to submit a video ad to search engines 130 is described in further detail with respect to FIG. 7.

At step 430 viewer 120 visits a Web page that displays the video ad and requests playback of the video ad. Typically, the first frame of a video ad is displayed in a rectangular window in the Web page and viewer 120 uses a play control also displayed in the rectangular window to request playback. Typically, in response to the user action the Web browser sends a request message to video ad server 115 requesting the playlist which corresponds to the desired video ad. The request message typically includes information about viewer 120 such as demographic information, and/or information about viewer client computer 125 such as its IP address or geographic coordinates. Information about the viewer may come from information stored in Web browser cookies. In addition, intermediaries, such as ad networks, may supply information about the viewer.

At step 435, video ad server 115 transfers, or downloads, the playlist corresponding to the video ad to the Web browser. At step 440, the Web browser running in client computer 125 launches or runs a smart media player that processes each instruction in the playlist, thereby playing the video ad. During playback by the smart media player, viewer 120 may use playback controls provided by the smart browser to control playing. Such playback controls may include stop, pause, start, start over, fast forward, backward. During playback, the smart media player will request any media clips referenced in the playlist from video ad server 115.

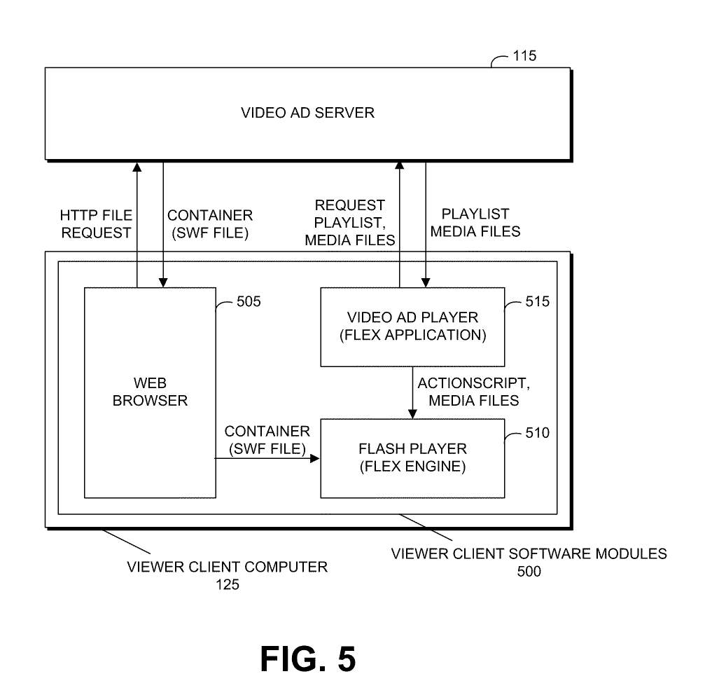

Reference is now made to FIG. 5, which is a simplified block diagram depicting the viewer client software, in accordance with an embodiment of the subject invention. A set of viewer client software modules 500 run in viewer client computer 125. In a preferred embodiment, the smart media player used to process a playlist is an ADOBEADOBE FLASH player 510 provided by ADOBE Systems Inc. Version 9 or later of FLASH player 510 is preferred. However, a comparable architecture can be used for other smart media players, e.g. the MICROSOFT WINDOWS MEDIA PLAYER provided by the Microsoft Corporation. And, as previously mentioned, in other embodiments, the Web browser itself acts as the smart media player. FLASH player 510 runs in conjunction with a Web browser 505 as an ActiveX control or a plug-in depending on which Web browser is called. For example, if Web browser 505 is Microsoft Internet Explorer than typically FLASH player 510 runs as an ActiveX control. ActiveX is a format defined by the Microsoft Corporation, Redmond, Wash. If Web browser 505 is Mozilla Firefox, then FLASH player 510 runs as a Firefox plug-in or extension as defined by Mozilla of Mountain View, Calif. In other embodiments, Web browser 505 itself includes smart media player functionality (e.g., the HTML5 standard) and no separate software modules are required.

FLASH player 510 operates as a “virtual machine,” commonly referred to as a “Flex engine,” that processes a programming language referred to as ActionScript. ActionScript is defined and maintained by ADOBE Systems, Inc. An ActionScript application defines the behavior of a FLASH player. In addition, FLASH player 510 processes a script language named SWF. A video ad player 515, which is an ActionScript program, or Flex application, processes playlists, stored in video ad server 115 and generates ActionScript code that is executed by FLASH Player 510. The ActionScript generated by video ad player 515 enables FLASH player 510 to correctly process the playlist in the native language, ActionScript, of FLASH player 510.

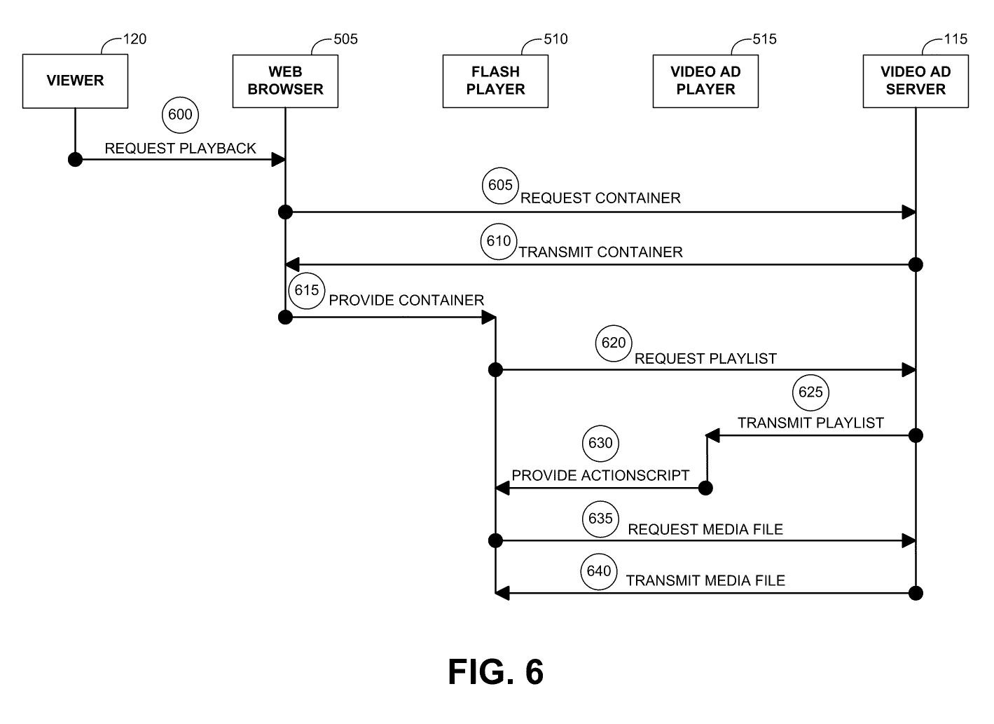

Reference is now made to FIG. 6, which is a simplified transaction diagram depicting the exchange of data between a Web browser, FLASH player, video ad player, and video ad server in response to a request for a video ad playback by a viewer, in accordance with an embodiment of the present invention. In a preferred embodiment described now with reference to FIG. 6, the smart media player used to process a playlist is FLASH player 510. At step 600 viewer 120 requests playback of a video ad. Typically the first frame of the video ad appears in a rectangular window in a Web page that he/she is viewing where the video ad will be played. In one embodiment, viewer 120 requests playback by clicking on the rectangular window or by clicking a play control that appears in the rectangular window. Web browser 505 responds to the playback request at step 605 by sending a request for a container file to video ad server 115. An example of the HTML code that generates the request is given below. In the example, HTML including the video ad “embed code” first defines a FLASH player object, which will operate in a 400 pixel width by 300 pixel high window. The embed code also includes an instruction to run FLASH player 510 in the Web page. As the initial operating instructions to the FLASH player 510, a file named main.swf is downloaded from video ad server 115. The embed code for this example is given below:

Example HTML “Embed Code” for embedding video ad system player:

<embed src=“http://www.mixpo.com/player/main.swf” quality=“high”
bgcolor=“#000000” width=“400” height=“300” name=“mixpo_player”
align=“middle” play=“true” loop=“false” quality=“high” allowScriptAccess=“always”
allowFullScreen=“true” FLASHvars=“guid=8583e7bb-4d30-4862-9239-
c1259adf6006&environment=&host=www.mixpo.com&forcePlay=false&autoPlay=fa
lse&autoPlayAudio=true” type=“application/x-shockwave-FLASH”
pluginspage=“http://www.adobe.com/go/getFLASHplayer”> </embed>

At step 610 video ad server 115 transmits the container file, main.swf, to requesting Web browser 505. At step 615 Web browser 505 runs the FLASH player and provides it with the container file. Main.swf constitutes the initial operating instructions for FLASH player 510. Main.swf is referred to as a container file because it contains instructions that define aspects of the player but does not include the video ad content itself. For example, main.swf defines visual characteristics of the player, such as its core functionality and which control buttons appear on the screen. Main.swf also contains instructions to request and download the playlist that specifies the requested video ad. These instructions include the GUID which uniquely references the playlist on video ad server 115. Then, at step 620 video ad player 515 requests the playlist associated with the GUID.

At step 625 video ad server 115 transmits the playlist. At step 630 video ad player 515 reads the playlist and at step 630 generates appropriate ActionScript code to enable FLASH player 510 to render the playlist using playback functionality provided by the FLASH player 510 engine, thus playing the video ad in the defined rectangle within the currently displayed HTML Web page. Since the playlist references but doesn't include media clips, video ad player 515 must request each media file from video ad server 115. Thus, step 635, requesting a media file by video ad player 515, and step 640, transmitting a media file by video ad server 115, are repeated for each media file referenced in the playlist.

Reference is now made to FIG. 7, which is a simplified block diagram of a video ad server, in accordance with an embodiment of the subject invention. After publisher 105 creates a video ad and specifies its publishing options, an uploader 700 uploads the playlist and stores it in a playlist database 725. Uploader 700 also uploads any corresponding media clips and stores them in a media clip database 730. Typically, uploader 700 uses the hypertext transfer protocol (HTTP) to upload files including a playlist and media clips. HTTP is a network protocol, standardized by the Worldwide Web Consortium, which is used to transfer data from one computer to another through a network, such as over the Internet.

A streamer 705 responds to requests to transmit playlists and media clips. Publisher client computer 110 requests playlists and media clips when publisher 105 edits or reviews video ads. Viewer client computer 125 requests playlists and media clips when viewer 120 requests playback of video ads. Streamer 705 responds to file transfer requests using the HTTP file transfer method. Other file transfer methods may also be used.

An analytics processor 710 collects viewing statistics from viewer client computer 125 and stores the data in an analytics database 735. Upon request from publisher client computer 110, analytics processor analyzes the stored data and provides analytic information that is displayed in an analytics dashboard, previously described with reference to FIG. 2D.

A syndicator 715 performs video search engine optimization, commonly referred to as video SEO, for each video ad for which publisher 105 has requested automatic submission as described with reference to FIG. 2C. Video SEO refers to a number of methods whose goal is to ensure that a video attracts as much traffic as possible. Syndicator 715 automatically submits each newly published video ad to leading search engines that index videos including inter alia GOOGLE Video Search, Yahoo! Video, and AOL® Video.

Syndicator 715 submits a video ad to a search engine using a method defined by the search engine. This ensures that the search engine lists the video ad among the search engine results and provides accurate information concerning the video ad. For example, in order to submit a video ad to the TRUVEO video search engine that indexes videos hosted by other sites, syndicator 715 creates a media RSS (mRSS) feed upon request and makes it available to the TRUVEO search engine electronically through a previously established “Director Account.” Once an mRSS feed is submitted, a TRUVEO crawler retrieves the feed periodically throughout each day, verifies the video ads, indexes the metadata included with the video ads, and integrates the video ads into a TRUVEO video search index which enables searching of videos. Each video ad included in the TRUVEO video search index can be discovered through search using an ordinary Web browser. When the video ad appears in a search result set TRUVEO provides some relevant metadata (title, description, format, etc.) and a thumbnail image representing the video ad. When a user clicks on the video in the TRUVEO results page, they are directed to a Web page that includes the video ad. TRUVEO is a search engine operated by AOL, Inc. AOL, Inc. is headquartered in New York, N.Y.

Syndicator 715 performs comparable methods to that described above to syndicate video ads to a plurality of search engines. For example, Syndicator 715 uses a method, referred to as video sitemaps, to publish and syndicate video ads to the GOOGLE VIDEO search engine.

For each video ad, syndicator 715 creates a static Web page. This ensures that for each video ad submitted there is a fixed URL that can be submitted to search engines such that the search engines can periodically crawl the static Web page to verify that it indeed exists. Further, the static Web page for the video ad includes descriptive metadata including inter alia a title, thumbnails from the different media elements in the playlist, and business information regarding publisher 105 that will ensure that the video ad is accurately and thoroughly indexed by search engines.

Syndicator 715 stores information required to perform different syndication methods as well as a static Web page for each video ad in search engine optimization (SEO) database 740.

Data storage 715 includes a relational database management system (RDBMS), three relational databases as previously discussed, and a physical storage system. The physical storage system includes online disk storage and backup storage. In addition, the physical storage system may include a remote, hosted, storage system, such as the S3 storage system provided by AMAZON of Seattle, Wash. In one embodiment, the three databases, playlist database 720, media clip database 725, and SEO database 730 are stored centrally on one or more disk storage systems. In an alternative embodiment, media clips are stored in remote, hosted storage while playlist database 720 and SEO database 730 are stored centrally. In a further embodiment, media clips are stored in a content delivery network (CDN). A CDN is a system of computers networked together across the Internet that cooperate transparently to deliver content (especially large media files) to end users. CDN storage is provided by a number of companies including Akamai Technologies, Inc. of Cambridge, Mass., and EdgeCast Networks of Santa Monica, Calif.

It will be appreciated by those skilled in the art that the systems and methods of the present invention may be implemented within a variety of client-server hardware and network architectures. In this regard, reference is now made to FIG. 8, which is a simplified block diagram depicting an example hardware architecture for implementing a video ad server, in accordance with an embodiment of the present invention. On the server side, the architecture in FIG. 8 includes a firewall 810, one or more Web application servers 830 managed by load balancers 820, one or more administration servers 850, an analytics processor 840 computer system, and four databases. The databases include a playlist database 860 for storing playlists, including the data from playlist database 720 shown in FIG. 7, a media clip database 862 for storing media clips, including the data from media clip database 730, an analytics database 864 for storing statistics and analytics information including the data from analytics database 735, and a SEO database 866 for storing SEO information and static Web pages, including the data from SEO database 740. It will be appreciated by those skilled in the art that FIG. 8 refers to physical database storage systems, while the databases in FIG. 7 refer to the data files that comprise a database, which may be implemented by a wide range of physical storage architectures. Web application servers 830 manage analytics processor 840, playlist database 860, media clip database 862, analytics database 864, and SEO database 866. All of these server components are subsumed in video ad server 115.

On the client side, the architecture in FIG. 8 includes publisher client computer 110, viewer client computer 125, and search engines 130. Publisher client computer 110 has a two-way connection with load balancers 820 for uploading and downloading playlists and media clips. Viewer client computer 125 has a two-way connection with load balancers 820 for downloading playlists and media clips and for uploading viewing statistics. Search engines 130 have two-way connections with load balancers 820 for receiving video ad syndication data and performing a syndication data protocol.

### Selection and Generation of Video Ads

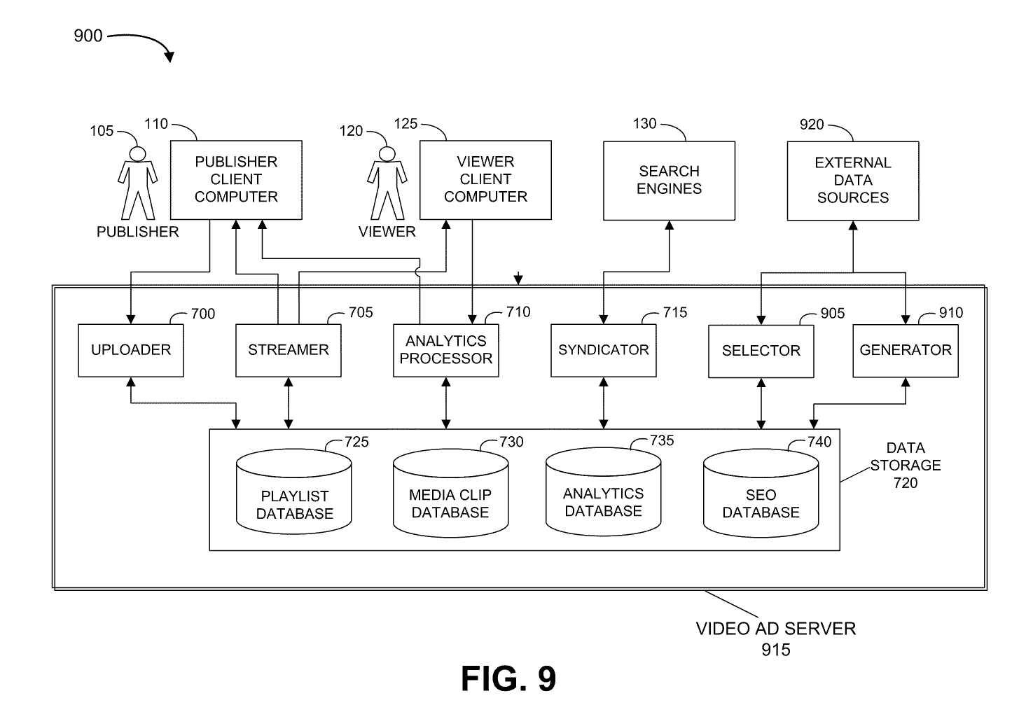

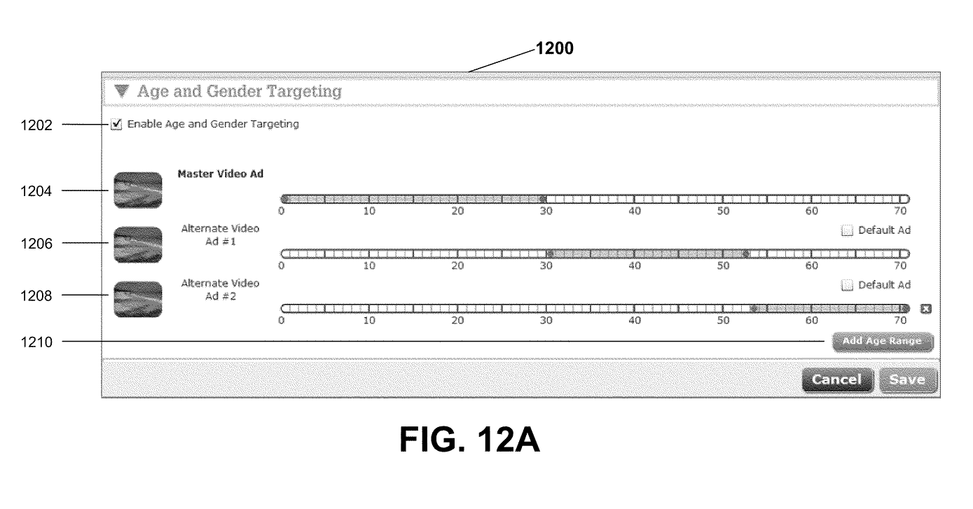

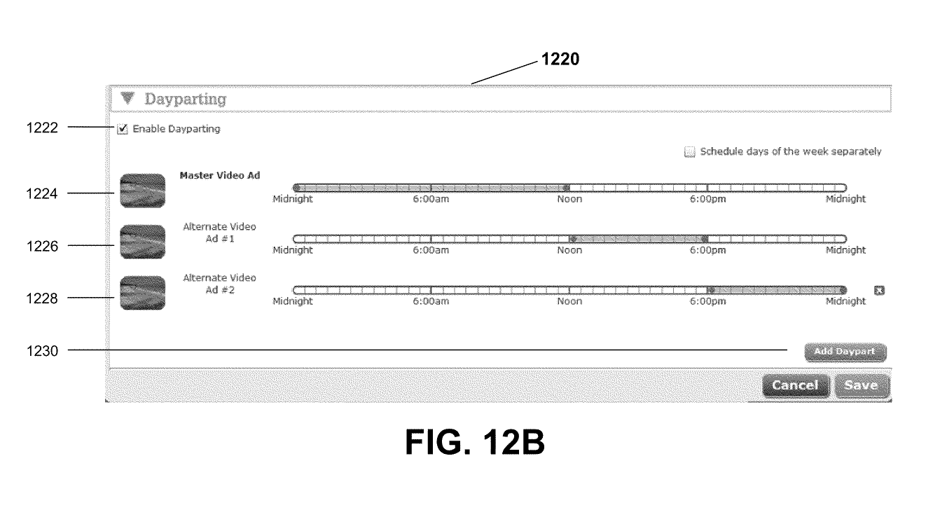

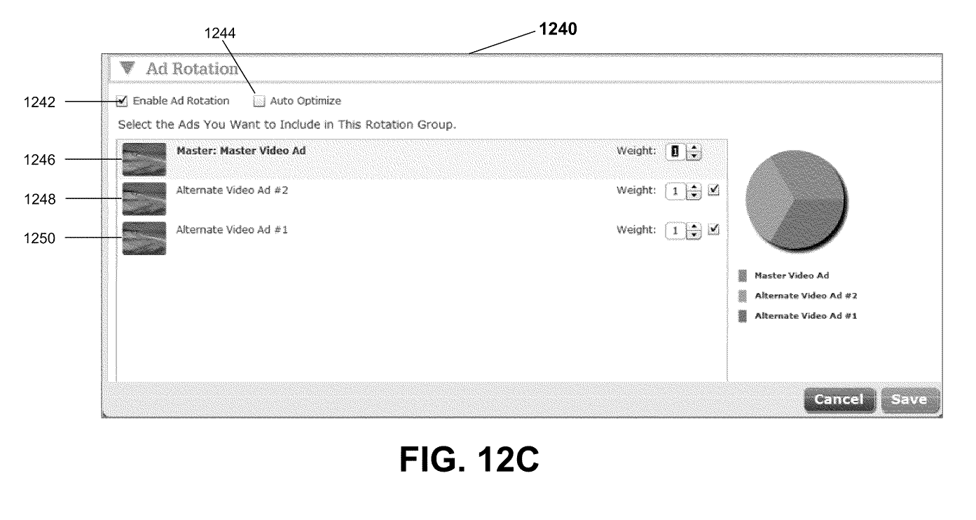

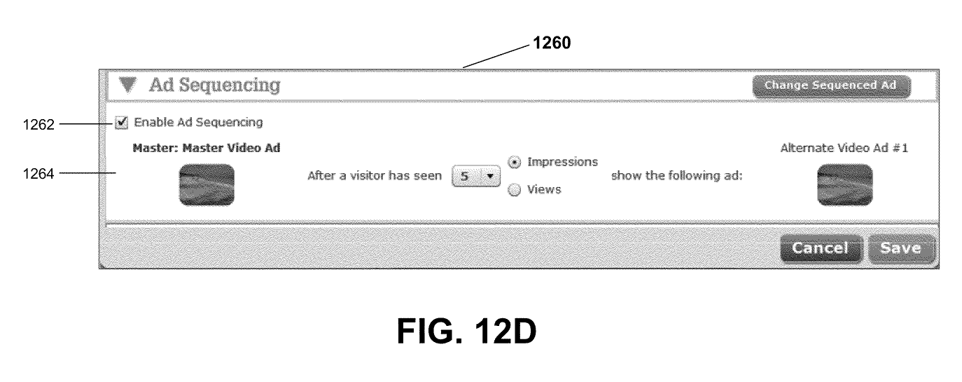

Now reference is made to FIG. 9, is a block diagram of a video ad publishing system and a video ad server that enables the selection of video ads based on criteria established by a publisher and the automatic generation of video ads, in accordance with an embodiment of the subject invention. Video ad publishing system 900 enables publisher 105 to create a group of alternative video ads and to specify criteria that guides the selection of which video ad to provide in response to a request from a viewer. In a preferred embodiment, publisher 105 specifies criteria that enable a video ad server 915 to select a video ad from a group of alterative video ads and to supply the selected video ad to viewer client computer 125. The viewer's response to the video ad is measured and provided to publisher 105 using user interfaces such as those depicted in FIG. 2D or in reports. In one embodiment, publisher 105 specifies video ad selection criteria using interactive user interfaces available through the dashboard such as those depicted in FIGS. 12A-D. Alternatively, the criteria can be supplied by publisher 105 in data files or through other mechanisms. Additionally, video ad server 915 is also capable of generating video ads according to instructions supplied by publisher 105 using publisher client computer 110 as described hereinbelow.

Video ad server 915 expands on video ad server 115 by adding a selector 905 for selecting a video ad from a group of alternative video ads and a generator 910 for generating video ads. In addition, video ad server 915 can retrieve data from one or more external data sources 920. In other respects video ad server 915 is similar to video ad server 115. Thus, only the additional elements in video ad server 915 are described hereinbelow.

External data sources 920 may be any source of data external to video ad server 915 including inter alia publicly available databases, cloud services that supply information, and websites.

Sequencer 905 provides user interfaces, such as the exemplary user interfaces provided in FIGS. 12A-D, to publisher client computer 110 that enable publisher 105 to specify criteria and instructions for creating video ad sequences. Selector 905 implements the logic to interpret the user specifications and to select a video ad from a group of alternative video ads where each video ad in the group is specified in a playlist stored in playlist database 725. Selector 905 stores selection criteria in playlist database 725. Selector 905 may obtain information from external data sources 920 to enable it to select a video ad.

Generator 910 implements the logic necessary to generate custom video ads based on instructions from publisher 105. One method for enabling publisher 105 to specify how generator 910 generates custom video ads is described hereinbelow with reference to geotargeting. This approach can be generalized to enable automatic generation of a broad class of video ads. Generator 910 is capable of accessing data from external data sources 920. An example of such is described hereinbelow with reference to geotargeting.

### Selecting Video Ads Based on Criteria

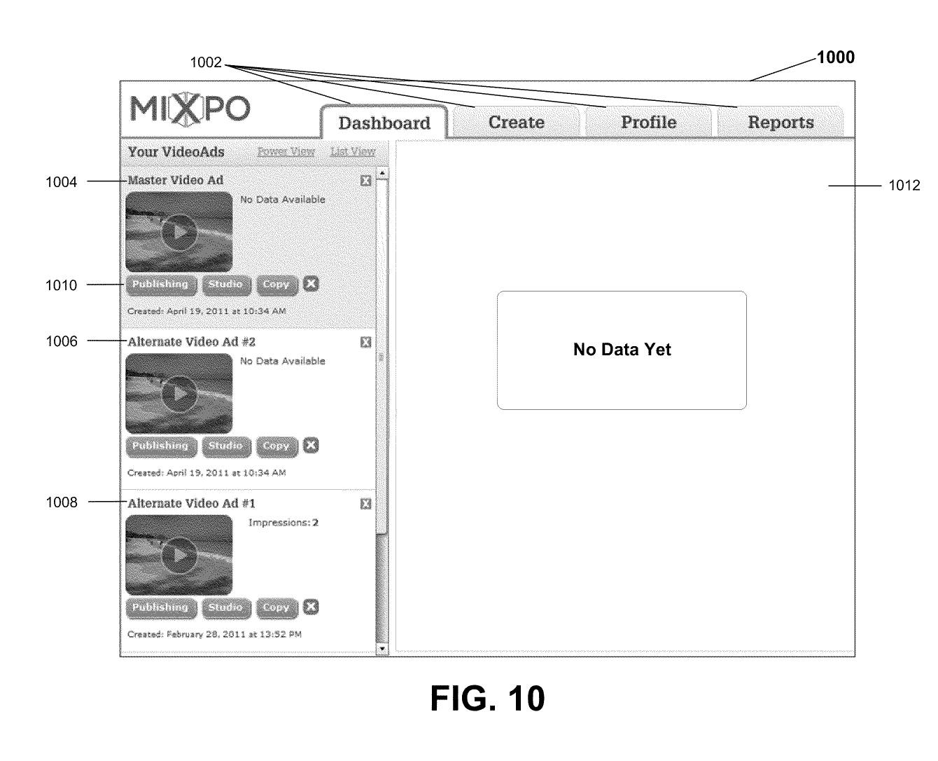

Reference is now made to FIG. 10 which is an exemplary dashboard user interface that enables a publisher to manage video ads, create new video ads based on an existing video ad, and to view performance results for video ads, in accordance with an embodiment of the subject invention. An exemplary dashboard interface 1000 provides a set of controls 1002 that enable publisher 105 to view his/her dashboard, create new video ads, edit existing video ads, establish a profile and view and specify reports. In dashboard interface 1000 the dashboard tab is selected from controls 1002. In a preferred embodiment, exemplary dashboard interface 1000 is implemented as an interactive Web page accessed from a standard Web browser running on publisher client computer 110. In another embodiment a client application is provided for use by publisher 105 on publisher client computer 110. Along the left side of dashboard interface 1000 a list of video ad control panels 1004, 1006, 1008 are displayed, each video ad control panel corresponds to one video ad stored on video ad server 915. Each video ad control panel includes a thumbnail and a set of panel controls 1010. Panel controls 1010 include (1) a “Publishing” control that enables publisher 105 to view and set publishing options for the video ad, (2) a “Studio” control that launches a video ad editor that enables publisher 105 to edit the video ad, and (3) a “Copy” control that enables the publisher to create alternative versions of the selected video ad. In exemplary dashboard interface 1000 video ad control panel 1004, which corresponds to a video ad named “Master Video Ad,” is selected. An analytics window 1012 shows analytics for the selected video ad. Because the selected ad hasn't yet been published, i.e., hasn't yet been downloaded and viewed, no viewer data has been collected as yet and therefore no analytic information is displayed; instead a message “No Data Yet” is shown. In one embodiment the four analytics displays, depicted in FIG. 2D, display in analytics window 1012 once data has been collected for the selected video ad.

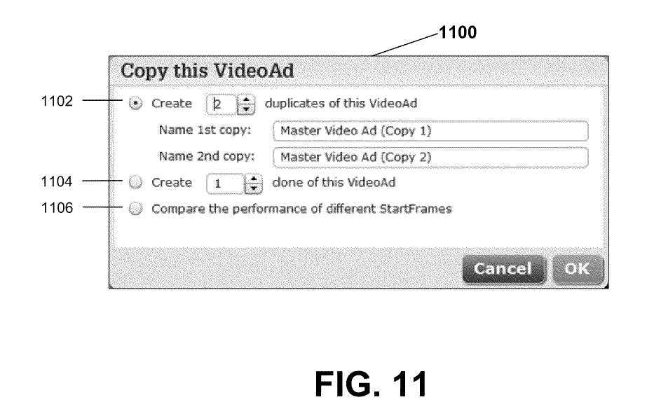

Now reference is made to FIG. 11, which is an exemplary user interface that enables a publisher to create one or more copies of a video ad, in accordance with an embodiment of the subject invention. A create duplicates control 1102 enables publisher 105 to specify the number of duplicates of a selected video ad to create and to give a name to each duplicate. A create clones control 1104 enables publisher 105 to specify the number of clones of the video ad to create. A compare control 1106 enables publisher 105 to request that the video ad server compare the performance of different start frames used in each of the duplicates or clones.

Now reference is made to FIG. 12A, which is an exemplary user interface that enables publisher to specify an age interval to be used among the criteria for selecting from among a plurality of video ads to provide in response to a request to view a video ad, in accordance with an embodiment of the subject invention. Exemplary user interface 1200 enables a publisher to specify an age interval for a selected video ad. The video ad is only provided to a viewer whose age falls within the specified age interval. Typically, the age of the viewer is provided by viewer client computer 125 in the request to view a video ad. Alternatively, the viewer's age can be obtained from external data sources 920. This feature enables a publisher to test the performance of different ads with respect to different age groups. Publisher 105 uses an enable control 1202 to specify that age and gender targeting is to be applied. In exemplary user interface 1200 age ranges are specified for three selected video ads using three corresponding age range controls 1204, 1206, 1208. Additional video ads can be selected for testing using an “add age range” control 1210. An option in exemplary user interface 1200 enables publisher 105 to specify a gender for each age range, or to specify a gender alone in which case the corresponding ad is tested for gender with no age constraint.

Now reference is made to FIG. 12B, which is an exemplary user interface that enables publisher to specify time of day criteria to be used to select from among a plurality of video ads, in accordance with an embodiment of the subject invention. Exemplary user interface 1220 enables a publisher to specify a time interval during which a selected video ad will display. When time of day criteria are enabled, a video ad is only provided to a viewer during one or more specified time intervals during a day. This feature, commonly referred to in the advertising industry as dayparting, enables a publisher to test the performance of different ads at different times of day.

Publisher 105 uses an enable control 1222 to specify that dayparting criteria is enabled. In exemplary user interface 1220 a non-overlapping time interval is specified for each of three selected video ads using three corresponding dayparting controls 1224, 1226, 1228. Additional video ads can be selected and added to the group being tested using an add daypart control 1230. In other embodiments, more than one time interval can be specified for a video ad and time intervals may be specified for selected days, weeks or months. Other embodiments enable arbitrary specifications of time periods during which a video ad is provided.

Now reference is made to FIG. 12C, which is an exemplary user interface that enables publisher to specify the relative percentage of times that a video ad will be selected from among a plurality of video ads, in accordance with an embodiment of the subject invention. Exemplary user interface 1240 enables a publisher to specify a relative weight for each selected video ad, the relative weight determining the relative percentage of times the video ad will be provided or selected by video ad server in response to requests to provide a video ad for display. This feature, commonly referred to in the advertising industry as ad rotation, enables a publisher to rotate several ads rather than show the same one each time.

Publisher 105 uses an enable control 1242 to enable ad rotation, i.e., to enable use of relative weights as a selection criterion. In exemplary user interface 1240 a positive integer value is specified for each of the three selected video ads, referred to as a rotation group, using three corresponding ad rotation controls 1246, 1248, 1250.

The ad rotation feature can be used within groups of ads that are also part of dayparting or age/gender groups. For example, if a video ad that is scheduled to run between 10:00 am and 12:30 pm belongs to a video ad rotation group the other ads in the group rotate with a frequency determined by their respective weight during the 10:00 am-12:30 pm time interval. Similarly a video ad included in an age/gender group can be rotated.

Publisher 105 uses an auto-optimize control 1244 to enable auto-optimization of video ads in a rotation group. When enabled, the best performing video ad or video ads in the group over a designated evaluation period is/are selected and used exclusively after the evaluation period. In one embodiment, after the evaluation period the best performing ad is determined and the ad is used exclusively from then on. Performance metrics that can be used by video ad server 915 to assess relative performance of video ads in a group include inter alia (1) the ratio of views to impressions, (2) average clickthrough rate, and (3) average percent of the video ad viewed. In a preferred embodiment, publisher 105 can select the performance metric to be used to assess performance by video ad server 915.

Now reference is made to FIG. 12D, which is an exemplary user interface that enables publisher to specify a sequence of video ads to be provided in response to successive requests for video ads, in accordance with an embodiment of the subject invention. Exemplary user interface 1260 enables a publisher to specify a master video ad to display for a specified number of consecutive views followed by a second video ad that is similarly displayed for a specified number of consecutive views.

Publisher 105 uses an enable control 1262 to enable video ad sequencing. Then, using controls in ad sequencing window 1264, publisher 105 specifies a first, or master, video ad to show for a specified number of impressions or views to show the master video ad to a viewer. Then publisher 105 specifies a second video ad to provide after the specified number of impressions or views to the same visitor. In a preferred embodiment, the second video ad displays for the same number of impressions or views specified for the master video ad. In another embodiment, publisher 105 can specify the number of impressions or views for the second video ad.

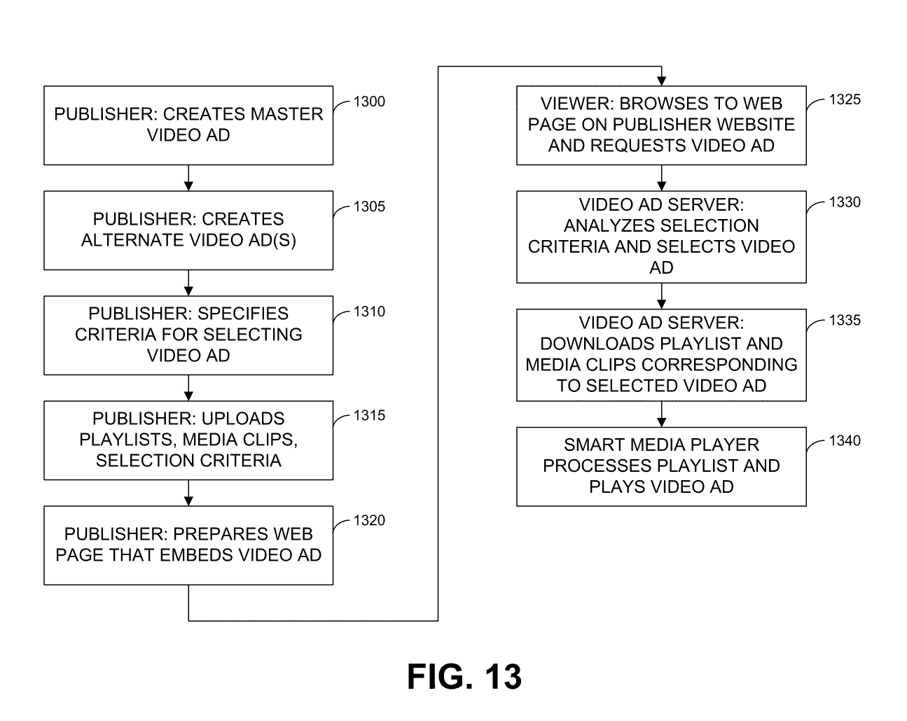

Now reference is made to FIG. 13, which is a simplified flow diagram depicting an overall method that enables a publisher to create a plurality of video ads and to specify criteria for selecting among the plurality of video ads and which enables a video ad server to select from among a group of alternative video ads, in accordance with an embodiment of the subject method. In FIG. 13, the term “publisher” may refer to actions performed by publisher 105, actions performed publisher client computer 110 acting on behalf of publisher 105 or publisher client computer 110 executing instructions on its own. The role of publisher 105 and publisher client computer 110 in each step is clarified in the discussion hereinbelow. Similarly, in FIG. 13 the term “viewer” may refer to actions performed by viewer 120, actions performed viewer client computer 125 acting on behalf of viewer 120 or to the viewer client computer 125 executing instructions on its own. The role of viewer 120 and viewer client computer 125 in each step is clarified in the discussion hereinbelow.

At step 1300 publisher 105 creates a video ad, referred to in this discussion as the master video ad, using publisher client computer 110. Typically, publisher 105 uses a video ad editor program such as that described with reference to FIG. 2A, to create the master video ad. At step 1305 publisher 105, using publisher client computer 110, creates one or more alternate video ads. In a preferred embodiment, publisher 105 uses the copy function described with reference to FIG. 11 to create initial versions of the alternate video ads. Then publisher 105 uses an editor to make modifications to each of the alternate video ads. Typically, publisher 105 modifies one or more of the master video ad media clips and/or one or more of the textual elements of the master video ad to create an alternate video ad.

Next, at step 1310 publisher 105 selects the master video ad and the alternate video ads and specifies criteria to be used by video ad server 915 to select a video ad from among the video ads. The selection criteria may include inter alia age or gender targeting, described with reference to FIG. 12A, dayparting, described with reference to FIG. 12B, ad rotation, described with reference to FIG. 12C, and ad sequencing, described with reference to FIG. 12D.

At step 1315 publisher client computer 110 generates a playlist for each video ad created by publisher 105 and uploads the playlist together with any included media items, along with the selection criteria to video ad server 915. Video ad server 915 stores the playlists and selection criteria in playlist database 725 and the media clips in media clip database 730.

At step 1320 publisher 1320 creates a new web page, or edits an existing web page, in which to incorporate, or embed, the master video ad.

At step 1325 viewer 120 uses viewer client computer 125 to browse to a web page on publisher website 135 that includes the master video ad. Viewer client computer 125 and requests the master video ad from video ad server 915. It may be appreciated by one skilled in the art, that the master video ad may be included in a plurality of web pages on a plurality of websites and that this method works identically regardless of which particular Web page and which particular website the master video ad is included in. Viewer client computer 125 typically encodes location information about viewer client computer 125 and/or information about viewer 120 in the request message that it sends to video ad server 915.

At step 1330 video ad server 915, in response to the received request to provide the master video ad, retrieves the criteria for selecting a video ad that corresponds to the master playlist stored in playlist database 725. Video ad server 915 then analyzes the criteria in order to determine which of the video ads to select, from the group that includes the master video ad and the alternate video ad(s), for downloading to viewer client computer 125.

At step 1335 video ad server 915 downloads the selected video ad to viewer client computer 125 to be played for viewer 120.

At step 1340, viewer client computer 125 provides the playlist to the smart media player which processes the playlist and plays the custom video ad for viewer 120.

### Generating Custom Video Ads—Geotargeting

In the foregoing discussion, a video ad is selected based on criteria specified by publisher 105. In addition, video ad server 915 is capable of generating, or creating, custom video ads based on inter alia (1) information provided by viewer client computer 125, (2) information provided by publisher 105 via publisher client computer 110, such as geotargeting profiles described hereinbelow, and (3) information retrieved by video ad server 915 from external data sources 920. One embodiment of this capability is referred to as geotargeting in which a video ad is created in real-time, by video ad server 915, and incorporates content customized to the geographic location of a viewer. As used herein the term geotargeting means creating and delivering content customized for viewers based on the viewers' locations.

The geotargeting system described herein uses information about the location of a viewer client computer 125, referred to herein as geographic location data, as an index to retrieve or select content that is specific for the location and then creates a custom video ad using the retrieved or selected content. In one embodiment, viewer client computer 125 includes its IP address in a request for a video ad. Video ad server 915 uses this IP address to determine geographic location data for viewer client computer 125. Such geographic location data may include inter alia country, state, city, zip code, designated market area (DMA), telephone area code and latitude and longitude coordinates. In another embodiment viewer client computer 125 provides its latitude and longitude coordinates to video ad server 915.

In geotargeting, publisher 105 creates and uploads to video ad server 915 a video ad template and a geotargeting profile. A geotargeting profile is, in a preferred embodiment, a comma separated value (CSV) formatted file. The geotargeting profile specifies the variables whose values will be used to create a custom video ad. The following is a simple example of a geotargeting profile used for a national auto dealer advertising campaign. The profile, displayed in table format, is organized around zip code where the variables are the zip code, a distance in miles from the zip code, an email address, a description of a sales offer in textual form, a phone number of the dealer covering this geographic area and a URL to be used to direct the viewer's browser if the viewer clicks on the video ad:

TABLE 1
EXAMPLE GEOTARGETING PROFILE

| zip- | dis- | | | | |
|---|---|---|---|---|---|
| code | tance | email | offer | dealer_phone | click_url |
| 98033 | 10 | lead@leej.com | Free golf club | (425) 823-0800 | www.leejohnsonchevy.com |
| 98045 | 15 | info@gmpsdealer.com | 10% Discount | (425) 888-0781 | www.chaplins.gmpsdealer.com |
| 98055 | 10 | lead@goodchevrenton.com | Dinner for Two | (425) 235-2000 | www.goodchevrenton.com |
| 98125 | 12 | lead@billpierrechevrolet.com | Test Drive Today | (206) 363-6110 | www.billpierrechevrolet.com |

The first row in the above example defines the geographic location data to be used as an index, in this case zip_code and distance, and four custom variables, email, offer, dealer_phone, and click_url. Each subsequent row includes the variable values that correspond to specific geographic data, in this case a zip code (zip_code) and distance from the zip code (distance). When the custom variables defined in the profile are used in a video ad template, the video ad is updated, or customized, using the variable data by video ad server 915, in real-time to create a custom video ad which is then provided to viewer client computer 125 to be played to viewer 120. For example, a viewer within 10 miles of the 98115 zip code will see the free consultation offer. A viewer within 15 miles of the 98045 zip code will see the “10% Discount” offer. If a video ad that uses the example geotargeting profile includes a lead form, utilizing the email variable, then leads received from viewers in the 98045 zip code are emailed by video ad server 915 to info@gmpsdealer.com. Leads received from viewers in the 98033 zip code are emailed to lead@leej.com.

There are two types of geotargeting variables: input variables and custom variables. Input variables are generally geographic location data elements such as country, city state, zip code, area code, and geographic coordinates. Custom variables are defined by publisher 105. Their values are specified in a geotargeting profile. For example, in the example geotargeting profile given in TABLE 1, above, the input variables are zip-code and distance and the custom variables, defined by publisher 105, are email, offer, dealer_phone and click_url.

In one embodiment, to create a video ad that will be generated in real-time by ad server 915 publisher 105 uses an interactive video ad editor, such as that described with reference to FIG. 2A, and places custom and/or input variables into fields and overlays where textual information is found. A variable name is entered immediately following a special character which in one embodiment is the dollar sign, “$”.

FIG. 14 provides an example of how a publisher specifies a video ad that will be generated on the fly, in accordance with an embodiment of the subject invention. Exemplary user interface 1400 depicts a video ad template specified by publisher 105. Exemplary user interface displays the visual elements of a video ad, as might be shown by a video ad editor such as that provided in FIG. 2A. One of the elements in the video ad is a text overlay 1402 that uses two geotargeting variables. The system variable $city, with default value “Seattle”, will be replaced by the name of the city corresponding to the location of viewer client computer 125. The system variable $phone in text overlay 1402 with default value “800-555-0177” will be replaced by the phone number of the nearest agent, which is included in a row in a geotargeting profile for which the value of the city column corresponds to the city determined for viewer client computer 125. As previously mentioned, when viewer 120 requests to view the video ad, he/she uses a play control such as play control 1404 to play or view the video ad. In response, viewer client computer 125 sends a request message to video ad server 115 that includes location information, e.g. IP address or geographic coordinates. In turn, video ad server 915 analyzes the location information included in the request message to obtain geographic input variables including the city.

Snippet 1 below gives an example of the XML code excerpt, included in the playlist, for the video ad example depicted in FIG. 14 prior to substitution of the input variables. Essentially, it is an excerpt of the original XML generated by the studio upon creation by the publisher.

Snippet 1

<textoverlay actiontype=“websiteLink” alignment=“right”
backgroundalpha=“1” backgroundcolor=“0x000000”
backgroundtype=“none” bold=“true” duration=“5600” fontfamily=“Arial”
fontsize=“34” heightRatio=“0.105” starttime=“14700”
textcolor=“1401766” timelineindex=“2” transitionouttype=“1”
transitiontype=“1” type=“0”
url=“$click_url(http://www.travelagent.com/seattle/)” widthRatio=“0.518”
xRatio=“0.001” yRatio=“0.579”>
<content>Call your $city(Seattle) agent today at: $phone(800-555-
0177)</content>
</textoverlay>

In Snippet 1, the custom variable $click_url is the default URL used to redirect the viewer's Web browser if the client clicks on the video ad during playback.

If the video ad is requested by a viewer that happens to be in Portland, then the Web browser running in viewer client computer 125 includes geographic information, such as the IP address of viewer client computer 125, in a request message that it sends to video ad server 115. Video ad server 115 determines the zip code of viewer client computer 125 and uses the geotargeting profile to obtain the proper replacement variables, which in this example are the city, phone number and click_url. Snippet 2 below gives the modified XML that will be provided by video ad server 115 to viewer client computer 125 for display to viewer 120. In this example, the URL corresponds to a travel agent in Portland, and the content includes the message “Call your Portland agent today at: 800-444-2134.” It may be noted that the click_url, which is not displayed to viewer 120, is also modified to reflect the Portland location.

Snippet 2

<textoverlay actiontype=“websiteLink” alignment=“right”
backgroundalpha=“1” backgroundcolor=“0x000000”
backgroundtype=“none” bold=“true” duration=“5600” fontfamily=“Arial”
fontsize=“34” heightRatio=“0.105” starttime=“14700”
textcolor=“1401766” timelineindex=“2” transitionouttype=“1”
transitiontype=“1” type=“0” url=“http://www.travelagent.com/portland/”
widthRatio=“0.518” xRatio=“0.001” yRatio=“0.579”>
<content>Call your Portland agent today at: 800-444-2134)</content>
</textoverlay>

In addition to modifying textual elements, media elements including inter alia images, sounds, music, and videos can be modified using the approach of indexing geotargeting profiles using input variables. For example, a column in a geotargeting profile can include filenames of media elements to use in generating a video.

### Other Examples of Automatically Generated Video Ads

Geotargeting is an example of an application where the input data is geotargeting data derived from information about the location of viewer client computer 125. Video ad server 915 also generates video ads based on viewer data, i.e. data supplied to video ad server 915 concerning viewer 120. Examples of viewer data include past purchasing history, explicit and deduced preferences by viewer 120.

For example, if a video ad is published by an auto dealer where viewer 120 previously purchased an auto, then the auto dealer may have information about the past purchasing history of viewer 120. For example, if viewer 120 previously purchased a LANDROVER vehicle from dealer #1015, then, when viewer 120 visits the website of dealer #1015 viewer client computer 125 encodes two items of input data, auto=landrover, and dealer=1015. In response, video ad server 915 generates a video ad using related video clips, offers, images, and other elements that have previously been provided by dealer #1015 acting as publisher 105.

In a second example, a Seattle clothing company named Seattle Clothes includes video ads on its e-commerce website. The Seattle Clothes company maintains a buyer purchase history for its clients and determines that viewer 120 has a preference for jackets and sweaters. Thus, when viewer 120 visits the website of Seattle Clothes, viewer client computer 125 encodes four items of input data, IP address=124.121.234.111, Publisher=Seattle Clothes, preference1=jacket, preference2=sweater. In response, video ad server 915 first makes a call to a weather database, which is an external data source 920, to determine the current weather at the location of viewer client location 125, determined by video ad server 915 from the supplied IP address, then creates a video ad that starts with text that relates to the weather, such as “Clothing for a rainy day . . . ”, and then shows two consecutive video clips selected from a number of clips supplied by Seattle Clothes, the first clip for jackets and the second for sweaters.

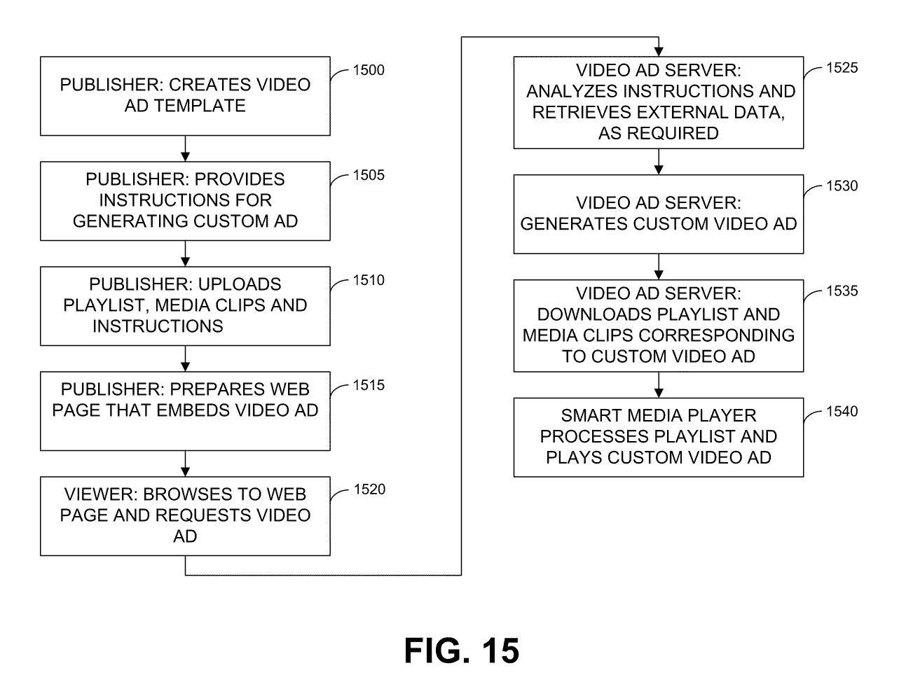

Now reference is made to FIG. 15, which is a simplified flow diagram depicting an overall method that enables a publisher to specify instructions for generating a custom video ad and which enables a video ad server to generate the custom video ad and to download it to a viewer client computer, in accordance with an embodiment of the subject method. In FIG. 15, the term “publisher” may refer to actions performed by publisher 105, actions performed publisher client computer 110 acting on behalf of publisher 105 or publisher client computer 110 executing instructions on its own. The role of publisher 105 and publisher client computer 110 in each step is clarified in the discussion hereinbelow. Similarly, in FIG. 15 the term “viewer” may refer to actions performed by viewer 120, actions performed viewer client computer 125 acting on behalf of viewer 120 or viewer client computer 125 executing instructions on its own. The role of viewer 120 and viewer client computer 125 in each step is clarified in the discussion hereinbelow.

At step 1500 publisher 105 creates a video ad, referred to in this discussion as the video ad template, using publisher client computer 110. Typically, publisher 105 uses a video ad editor such as that described with reference to FIG. 2A, to create the video ad template. At step 1505 publisher 105, using publisher client computer 110, specifies instructions that will be used by video ad server 915 to generate a custom video ad based on the video ad template. In one embodiment, this step is performed by embedding custom variables in the video ad template.

At step 1510 publisher client computer 110 generates a playlist for the video ad template and uploads the playlist together with any included media items, along with the instructions for generating a custom video ad to video ad server 915. In a preferred embodiment, the instructions are embedded inside the video ad template. In another embodiment, the instructions are stored separately from the video ad template. In another embodiment, the video ad template is a previously created video ad stored in data storage 720. In this embodiment, the instructions are uploaded at step 1510 but there is no need to also upload a video ad template or media clips.

At step 1515 publisher 105 prepares a Web page, or edits an existing Web page, in which to incorporate, or embed, the video ad template. The web page is part of publisher website 135.

At step 1520 viewer 120 uses viewer client computer 125 to browse to a web page on publisher website 135 that includes the video ad template. Viewer client computer 125 requests the video ad template from video ad server 915, typically but not necessarily in response to viewer 120 selecting the video ad template. Typically, viewer client computer 125 includes information about the viewer and/or information about viewer client computer 125 such as its IP address in the request message. It may be appreciated by one skilled in the art, that the video ad template may be included in a plurality of web pages on a plurality of websites and that this method works identically regardless of which particular Web page and which particular website the video ad template is included in. Viewer client computer 125 may encode location information and/or information about viewer 120 in the request message that it sends to video ad server 915.

At step 1525 video ad server 915, in response to the received request to provide the video ad template, reads the instructions for generating a custom video ad, which are stored in playlist database 725 along with the playlist corresponding to the video ad template. In this step, video ad server 915 analyzes the instructions and retrieves any required external data from external data sources 920.

At step 1530, video ad server 915 processes the instructions and generates the playlist for a custom video ad based on the video ad template.

At step 1535 video ad server 915 downloads the playlist corresponding to the generated custom video ad to viewer client computer 125.

Finally, at step 1540, viewer client computer 125 provides the playlist to the smart media player which processes the playlist and plays the custom video ad for viewer 120.

In reading the above description, persons skilled in the art will realize that there are many apparent variations that can be applied to the methods and systems described.

LISTING 1: Example Playlist

```
<container domain=“MX” duration=“79134” sessionid=“fTe-Z3O6QoQflB5PTu8T9A**”
friendlyurl=“http://www.mixpo.com/videoad/Example-
VideoAd/PbJI3DltQv6HyLc_5TAqiA” guid3db248dc-396d-42fe-87c8-b73fe5302a88”
logoguid=“5d6fb000-8ffe-4fa7-9534-d1756da81c94_LOGO” syndicated=“false”
title=“Example VideoAd” userkey=“5d6fb000-8ffe-4fa7-9534-d1756da81c94”
status=“A” version=“1.1”>
<useractions>
<useraction type=“emailcustomer”/>
<useraction type=“redirect” value=“http://www.mixpo.com/”/>
<useraction type=“play”/>
<useraction type=“impression”/>
<useraction type=“emailpublisher” value=“contact_email@mixpo.com”/>
<useraction type=“emailfriend”/>
<useraction type=“embedcode”/>
<useraction type=“copylink”/>
</useractions>
-
  <mediamanifest containerguid=“3db248dc-396d-42fe-87c8-b73fe5302a88”
friendlyurl=“http://www.mixpo.com/videoad/Example-
VideoAd/PbJI3DltQv6HyLc_5TAqiA” title=“Example VideoAd” version=“1.1”>
-
  <media domain=“MX” filename=“DSC01172” guid=“03e119dd-4e00-4a59-8ddf-
33887542c167” type=“image/jpeg” userkey=“5d6fb000-8ffe-4fa7-9534-
d1756da81c94”>
<representation filesize=“30764”>JPG1024</representation>
<representation filesize=“2872”>JPG128</representation>
<representation filesize=“11253”>JPG320</representation>
<representation filesize=“30764”>JPG640</representation>
</media>
-
  <media domain=“MX” filename=“IMG_1126” guid=“0778ec84-35d8-45bb-a4d0-
e69d084638de” type=“image/jpeg” userkey=“5d6fb000-8ffe-4fa7-9534-
d1756da81c94”>
<representation filesize=“122782”>JPG1024</representation>
<representation filesize=“3639”>JPG128</representation>
<representation filesize=“14059”>JPG320</representation>
<representation filesize=“46887”>JPG640</representation>
</media>
-
  <media domain=“MX” filename=“193_9371” guid=“131780e9-158b-4234-bb8f-
d3e832cf8d58” type=“image/jpeg” userkey=“5d6fb000-8ffe-4fa7-9534-
d1756da81c94”>
<representation filesize=“95047”>JPG1024</representation>
<representation filesize=“3080”>JPG128</representation>
<representation filesize=“12833”>JPG320</representation>
<representation filesize=“41341”>JPG640</representation>
</media>
-
  <media domain=“MX” filename=“DSC04002” guid=“14c8f811-1a21-4ac7-bfc8-
ffe95de304da” type=“image/jpeg” userkey=“5d6fb000-8ffe-4fa7-9534-
d1756da81c94”>
<representation filesize=“47951”>JPG1024</representation>
<representation filesize=“3694”>JPG128</representation>
<representation filesize=“15814”>JPG320</representation>
<representation filesize=“47951”>JPG640</representation>
</media>
-
  <media domain=“MX” filename=“retreat15” guid=“3365d57a-3215-4015-a78b-
668310f6a3d6” type=“image/jpeg” userkey=“5d6fb000-8ffe-4fa7-9534-
d1756da81c94”>
<representation filesize=“167056”>JPG1024</representation>
<representation filesize=“4133”>JPG128</representation>
<representation filesize=“21260”>JPG320</representation>
<representation filesize=“74337”>JPG640</representation>
</media>
-
  <media domain=“MX” duration=“25634” filename=“City/1
Crowds/Barcelona_Market.mp3” guid=“44de2b89-782f-4710-9527-b000a2faa341”
stockcode=“roy” type=“audio/mpeg” userkey=“smm”>
<representation filesize=“205009”>MP3</representation>
</media>
-
  <media domain=“MX” filename=“39230967.IMG_1219” guid=“703d5b96-ff56-4c11-
ab38-66e93e521b0c” type=“image/jpeg” userkey=“5d6fb000-8ffe-4fa7-9534-
d1756da81c94”>
<representation filesize=“91812”>JPG1024</representation>
<representation filesize=“4925”>JPG128</representation>
<representation filesize=“21479”>JPG320</representation>
<representation filesize=“66780”>JPG640</representation>
</media>
-
  <media domain=“MX” filename=“Ptarm010” guid=“a0677d5c-dd45-415d-939a-
60c408b02f19” type=“image/jpeg” userkey=“5d6fb000-8ffe-4fa7-9534-
d1756da81c94”>
<representation filesize=“115609”>JPG1024</representation>
<representation filesize=“3772”>JPG128</representation>
<representation filesize=“16872”>JPG320</representation>
<representation filesize=“52733”>JPG640</representation>
</media>
-
  <media domain=“MX” filename=“MVI_1544” guid=“b22c6e4d-37f7-4294-ba95-
093e885a041b” type=“video/x-flv” userkey=“5d6fb000-8ffe-4fa7-9534-
d1756da81c94”>
<representation filesize=“1263984”>FLV320</representation>
<representation filesize=“3396329”>FLV640</representation>
<representation filesize=“78567”>JPG1024</representation>
<representation filesize=“4776”>JPG128</representation>
<representation filesize=“3572”>JPG128_1</representation>
<representation filesize=“4940”>JPG128_10</representation>
<representation filesize=“4940”>JPG128_11</representation>
<representation filesize=“3887”>JPG128_12</representation>
<representation filesize=“3458”>JPG128_2</representation>
<representation filesize=“2698”>JPG128_3</representation>
<representation filesize=“4025”JPG128_4</representation>
<representation filesize=“4523”>JPG128_5</representation>
<representation filesize=“4951”>JPG128_6</representation>
<representation filesize=“5435”>JPG128_7</representation>
<representation filesize=“3489”>JPG128_8</representation>
<representation filesize=“4138”>JPG128_9</representation>
<representation filesize=“24688”>JPG320</representation>
<representation filesize=“78567”>JPG640</representation>
</media>
-
  <media domain=“MX” filename=“IMG_8117” guid=“bffdf594-9e42-4d1d-a5e7-
334ddf4462ac” type=“image/jpeg” userkey=“5d6fb000-8ffe-4fa7-9534-
d1756da81c94”>
<representation filesize=“118826”>JPG1024</representation>
<representation filesize=“4028”>JPG128</representation>
<representation filesize=“16528”>JPG320</representation>
<representation filesize=“52473”>JPG640</representation>
</media>
-
  <media domain=“MX” filename=“IMG_7115” guid=“c6bba46d-2bd1-484d-8304-
875f4435ceef” type=“image/jpeg” userkey=“5d6fb000-8ffe-4fa7-9534-
d1756da81c94”>
<representation filesize=“94239”>JPG1024</representation>
<representation filesize=“4449”>JPG128</representation>
<representation filesize=“17401”>JPG320</representation>
<representation filesize=“46538”JPG640</representation>
</media>
-
  <media domain=“MX” duration=“31475” filename=“Positive Music
Transcodes/1000_Miles/1000_Miles_Loop_A.mp3” guid=“d3939564-042a-4a2a-a0aa-
3c3a04ba157c” stockcode=“upbeat” type=“audio/mpeg” userkey=“smm”>
<representation filesize=“251821”>MP3</representation>
</media>
-
  <media domain=“MX” filename=“006_sawtooth_steeleman” guid=“daab28c5-a684-
42a2-ba5c-e38d9031ffc8” type=“image/jpeg” userkey=“5d6fb000-8ffe-4fa7-9534-
d1756da81c94”>
<representation filesize=“43632”>JPG1024</representation>
<representation filesize=“3270”>JPG128</representation>
<representation filesize=“14313”>JPG320</representation>
<representation filesize=“43632”>JPG640</representation>
</media>
-
  <media domain=“MX” filename=“MVI_1300” guid=“ee61ca9b-ce4e-4191-8fd1-
b2c5282a287b” type=“video/x-flv” userkey=“5d6fb000-8ffe-4fa7-9534-
d1756da81c94”>
<representation filesize=“475250”>FLV320</representation>
<representation filesize=“1306291”>FLV640</representation>
<representation filesize=“50516”>JPG1024</representation>
<representation filesize=“3713”>JPG128</representation>
<representation filesize=“1953”>JPG128_1</representation>
<representation filesize=“2387”>JPG128_10</representation>
<representation filesize=“2387”>JPG128_11</representation>
<representation filesize=“1893”>JPG128_12</representation>
<representation filesize=“2232”>JPG128_2</representation>
<representation filesize=“2477”>JPG128_3</representation>
<representation filesize=“2366”>JPG128_4</representation>
<representation filesize=“2227”>JPG128_5</representation>
<representation filesize=“2285”>JPG128_6</representation>
<representation filesize=“2387”>JPG128_7</representation>
<representation filesize=“2387”>JPG128_8</representation>
<representation filesize=“2387”>JPG128_9</representation>
<representation filesize=“15282”>JPG320</representation>
<representation filesize=“50516”>JPG640</representation>
</media>
</mediamanifest>
-
  <visualtimeline>
<slide duration=“4000” guid=“3365d57a-3215-4015-a78b-668310f6a3d6”
transitionin=“dissolve” transitioninduration=“1000”/>
<slide duration=“28967” guid=“b22c6e4d-37f7-4294-ba95-093e885a041b”
transitionin=“dissolve” transitioninduration=“1000”/>
<slide duration=“4000” guid=“a0677d5c-dd45-415d-939a-60c408b02f19”
transitionin=“dissolve” transitioninduration=“1000”/>
<slide duration=“12167” guid=“ee61ca9b-ce4e-4191-8fd1-b2c5282a287b”
transitionin=“dissolve” transitioninduration=“1000”/>
<slide duration=“4000” guid=“bffdf594-9e42-4d1d-a5e7-334ddf4462ac”
transitionin=“dissolve” transitioninduration=“1000”/>
<slide duration=“4000” guid=“c6bba46d-2bd1-484d-8304-875f4435ceef”
transitionin=“dissolve” transitioninduration=“1000”/>
<slide duration=“4000” guid=“0778ec84-35d8-45bb-a4d0-e69d084638de”
transitionin=“dissolve” transitioninduration=“1000”/>
<slide duration=“4000” guid=“14c8f811-1a21-4ac7-bfc8-ffe95de304da”
transitionin=“dissolve” transitioninduration=“1000”/>
<slide duration=“4000” guid=“03e119dd-4e00-4a59-8ddf-33887542c167”
transitionin=“dissolve” transitioninduration=“1000”/>
<slide duration=“4000” guid=“703d5b96-ff56-4c11-ab38-66e93e521b0c”
transitionin=“dissolve” transitioninduration=“1000”/>
<slide duration=“4000” guid=“131780e9-158b-4234-bb8f-d3e832cf8d58”
transitionin=“dissolve” transitioninduration=“1000”/>
<slide duration=“4000” guid=“daab28c5-a684-42a2-ba5c-e38d9031ffc8”
transitionin=“dissolve” transitioninduration=“1000”/>
</visualtimeline>
-
  <audiotimeline>
<audiotrack duration=“31475” guid=“d3939564-042a-4a2a-a0aa-3c3a04ba157c”
loop=“false” name=“1000_miles_loop_a” starttime=“0” trackduration=“31475”
type=“stock_sound” volume=“1”/>
<audiotrack duration=“25634” guid=“44de2b89-782f-4710-9527-b000a2faa341”
loop=“false” name=“1 Crowds” starttime=“39800” trackduration=“25634”
type=“stock_sound” volume=“1”/>
</audiotimeline>
-
  <texttimeline>
-
  <textoverlay alignment=“center” backgroundalpha=“1” backgroundcolor=“255”
backgroundtype=“rectangle” dropshadow=“false” duration=“9000” email=“null”
fontfamily=“Arial” fontsize=“22” heightRatio=“0.4926829268292683”
starttime=“4000” textcolor=“0” url=“http://www.seattletimes.com”
widthRatio=“0.5962804878048781” xRatio=“0.24518292682926832”
yRatio=“0.35195121951219516”>
<content>Text Overlay
Click here to go somewhere</content>
</textoverlay>
</texttimeline>
-
  <styling>
<redirectlabel>More Info</redirectlabel>
<emaillabel>Inquire</emaillabel>
<directresponsebuttons backgroundcolor=“#7DC900” bordercolor=“#FFFFFF”
textcolor=“#222222”/>
</styling>
<description>
this is the description block for an example mixpo videoad
</description>
<keywords>videoad, mixpo, mountains, skiing</keywords>
</container>
```

What is claimed is:

1. A method for publishing video ads, comprising:
i) providing, by a video ad server, a publisher interface for interactively specifying, by a publisher, (1) a plurality of video ads, and (2) criteria for selecting a video ad from the plurality of video ads, wherein a video ad comprises one or more media items and, optionally, one or more interactive controls;
ii) generating by the publisher interface a playlist for each of the plurality of video ads, wherein a playlist includes instructions that enable a smart media player to play a video ad and also includes references to said one or more media items;
iii) uploading, by the publisher interface, the playlists corresponding to the plurality of video ads and the criteria for selecting a video ad to a video ad server;
iv) in response to a request from a smart media player to play a video ad, selecting, by the video ad server, a video ad from the plurality of video ads, based on the specified criteria for selecting a video ad; and
v) providing the playlist corresponding to the selected video ad and the referenced media items to the smart media player.

2. The method of claim 1 wherein said specified criteria is selected from the group consisting of age of the viewer, gender of the viewer, location of the viewer, day of the week, time of day, number of times the selected video ad has been played, and a weight assigned by the publisher to each of the plurality of video ads.

3. The method of claim 1 further comprising receiving, by the video ad server, performance data from the smart media player for each video ad played by the smart media player and wherein the specified criteria for selecting a video ad is based on said performance data.

4. The method of claim 3 wherein said performance data for each video ad played is selected from the group consisting of the ratio of views to impressions, the average clickthrough rate, and the average percent viewed.

5. A network computing device, comprising:
i) a storage device useable to store (1) playlists, wherein a playlist specifies a video ad that comprises one or more media items and, optionally, one or more interactive controls, said playlist including instructions that enable a smart media player to play a video ad and also including references to said one or more media items, and (2) criteria for selecting a video ad from a designated plurality of video ads;
ii) a processor that is programmed to enable access to the storage device and to perform actions comprising:
receiving from a publisher computer (1) a plurality of playlists, and (2) criteria for selecting a video ad from the video ads specified by said plurality of playlists;
storing said plurality of playlists and said criteria in the storage device;
receiving a request from a smart media player for a playlist from among said plurality playlists;
selecting a video ad from the video ads specified by said plurality of playlists based on said criteria; and
providing the playlist corresponding to the selected video ad and the media items referenced by said playlist to the smart player.

6. The network computing device of claim 5, wherein the processor is operative to perform actions further comprising providing a publisher interface to a publisher computer for:
interactively specifying, by a publisher, (1) a plurality of video ads, and (2) criteria for selecting one of said plurality of video ads;
generating a playlist for each of said plurality of video ads; and
transmitting the generated playlists to the network computing device.

7. The network computing device of claim 5 wherein said specified criteria is selected from the group consisting of age of the viewer, gender of the viewer, location of the viewer, day of the week, time of day, number of times the selected video ad has been played, and a weight assigned by the publisher to each of the plurality of video ads.

8. The network computing device of claim 5 wherein the processor is operative to perform actions further comprising receiving performance data from the smart media player for each video ad played by the smart media player and wherein the specified criteria for selecting a video ad is based on said performance data.

9. The network computing device of claim 8 wherein said performance data for each video ad played is selected from the group consisting of the ratio of views to impressions, the average clickthrough rate, and the average percent viewed.

10. A method for publishing video ads, comprising:
i) providing, by a video ad server, a publisher interface that executes on a publisher computer, said publisher interface enabling a publisher to interactively specify (1) a first video ad, and (2) instructions for generating a second video ad from the first video ad, and wherein a video ad comprises one or more media items and at least one interactive control;
ii) generating by the publisher interface a playlist for the first video ad, wherein a playlist includes instructions that enable a smart media player to play a video ad and also includes references to said one or more media items;
iii) uploading, by the publisher interface, to the video ad server, the playlist for the first video ad and the instructions for generating a second video ad;
iv) in response to a request to play the first video ad from a smart media player that executes in a viewer computer, processing the instructions to generate a second video ad, by the video ad server, to generate a second video ad;
v) generating by the ad server a playlist that corresponds to the second video ad; and
vi) providing the playlist corresponding to the second video ad and the media items referenced by the playlist corresponding to the second video ad to the smart media player.

11. The method of claim 10 wherein the request from the smart media player includes information about the location of the viewer computer and the instructions for generating the second video ad include replacing at least one element in the first video ad with a corresponding element customized to the location of the viewer computer.

12. The method of claim 11 further comprising receiving by the ad server a location table wherein each row of the location table corresponds to a unique location and a designated column of the location table includes text that varies for each row, and wherein the at least one element in the first video ad that is replaced is a textual element and the corresponding element customized to the location of the viewer computer is text from the location whose row corresponds to the location of the viewer computer and the column is the designated column.

13. The method of claim 10 wherein the instructions for generating the second video ad include obtaining data from an external data source and including said data in the second video ad.

14. The method of claim 10 wherein the instructions for generating the second video ad are included as coded textual elements in the first video ad.

15. A network computing device, comprising:
i) a storage device useable to store (1) playlists, wherein a playlist specifies a video ad that comprises one or more media items and at least one interactive control, said playlist including instructions that enable a smart media player to play a video ad and also including references to said one or more media items, and (2) instructions for generating a second video ad from a designated video ad;
ii) a processor that is programmed to enable access to the storage device and to perform actions comprising:
receiving from a publisher computer (1) a playlist corresponding to a video ad, and (2) instructions for generating a second video ad from the received video ad;
storing said received playlist and said instructions in the storage device;
receiving a request from a smart media player, executing on a viewer computer, for the received playlist;
processing the instructions for generating a second video ad to generate a second video ad; and
providing the playlist corresponding to the generated second video ad and the media items referenced by said playlist to the smart player.

16. The network computing device of claim 15, wherein the processor is operative to perform actions further comprising providing a publisher interface to a publisher computer for:
interactively specifying, by a publisher, a video ad;
generating a playlist for the video ads; and
transmitting the generated playlist to the network computing device.

17. The network computing device of claim 15 wherein the request from the smart media player includes information about the location of the viewer computer and the instructions for generating the second video ad include replacing at least one element in the first video ad with a corresponding element customized to the location of the viewer computer.

18. The network computing device of claim 17 wherein the processor is operative to perform actions further comprising receiving a location table wherein each row of the location table corresponds to a unique location and a designated column of the location table includes text that varies for each row, and wherein the at least one element in the first video ad that is replaced is a textual element and the corresponding element customized to the location of the viewer computer is text from the location whose row corresponds to the location of the viewer computer and the column is the designated column.

19. The method of claim 15 wherein the instructions for generating the second video ad include obtaining data from an external data source and including said data in the second video ad.

20. The method of claim 15 wherein the instructions for generating the second video ad are included as coded textual elements in the first video ad.
